(19) United States
(12) Patent Application Publication
(10) Pub. No.: US 2017/0242405 A1
(43) Pub. Date: Aug. 24, 2017

(54) OPERATION INFORMATION PROVIDING APPARATUS, OPERATION INFORMATION PROVIDING SYSTEM, OPERATION INFORMATION PROVIDING METHOD, AND RECORDING MEDIUM

(71) Applicant: SEIKO EPSON CORPORATION, Tokyo (JP)

(72) Inventor: Tsubasa SHIRAI, Shiojiri-shi (JP)

(73) Assignee: SEIKO EPSON CORPORATION, Tokyo (JP)

(21) Appl. No.: 15/430,911

(22) Filed: Feb. 13, 2017

(30) Foreign Application Priority Data
Feb. 22, 2016 (JP) 2016-030999

(51) Int. Cl. G04F 10/00; A63B 71/06; A63B 69/06; H04Q 9/00

(52) U.S. Cl. CPC G04F 10/00; H04Q 9/00; A63B 71/0686; A63B 69/06; H04Q 2209/20; H04Q 2209/40

(57) ABSTRACT

An operation information providing apparatus that provides information regarding a repetitive operation which is synchronously performed by a first user and a second user, includes a processor that detects a deviation of a timing of an operation of the second user based on a timing of an operation of the first user by using an output of a first sensor detecting the operation of the first user and an output of a second sensor detecting the operation of the second user, and an output unit that outputs information indicating the positive or negative of the deviation of a case where the deviation is detected.

### BACKGROUND

1. Technical Field

The present invention relates to an operation information providing apparatus, an operation information providing system, an operation information providing method, and a recording medium.

2. Related Art

JP-A-2011-087794 discloses a system that computationally calculates a coincidence condition or a deviation condition (synchronization) of a movement for each body part of each user in gymnastics or dance performed by a group to thereby perform feedback output. In this system, a sample motion rhythm is fed back to a user as a tactile stimulus, and the tactile stimulus becomes stronger as a deviation of movement of a user becomes greater.

However, even when the degree of a deviation is fed back to individual users, it is considered that it is difficult to know how the individual users can correct their own movements in order to perform synchronization of the entirety of a group when there is no coaching of a person, such as an instructor or a coach, who is able to objectively observe the entire group, in the method disclosed in JP-A-2011-087794.

### SUMMARY

An advantage of some aspects of the invention is to provide an operation information providing apparatus, an operation information providing system, an operation information providing method, and a recording medium which are effective for a group practice performed by two or more users in order to learn a cooperative operation.

The invention can be implemented as the following configurations.

### APPLICATION EXAMPLE 1

An operation information providing apparatus according to this application example of the invention provides information regarding a repetitive operation which is synchronously performed by a first user and a second user, and includes a processor that detects a deviation of a timing of an operation of the second user based on a timing of an operation of the first user by using an output of a first sensor detecting the operation of the first user and an output of a second sensor detecting the operation of the second user, and an output unit that outputs information indicating a state of the deviation of a case where the deviation is detected.

The processor detects deviation of a timing of an operation of the second user based on a timing of an operation of the first user by using an output of the first sensor detecting the operation of the first user and an output of the second sensor detecting the operation of the second user. In addition, the output unit outputs information indicating the state of the deviation of a case where the deviation is detected.

In this specification, the “information indicating the state (positive or negative) of the deviation” means information indicating whether the timing of the operation of the second user is earlier or later than the timing of the operation of the first user. Therefore, the information indicating the state (positive or negative) indicates not only whether the operation of the second user is synchronized with the operation of the first user but also whether to relatively advance or delay the operation of the second user in order to bring the operation of the first user and the operation of the second user close to each other. Therefore, when, for example, at least one of the first user and the second user is notified of the information, it is easy to synchronize both the operations with each other. Therefore, the operation information providing apparatus of this application example is effective as an assistant for synchronizing the operation of the first user and the operation of the second user with each other.

### APPLICATION EXAMPLE 2

In the operation information providing apparatus according to the application example, the output unit may output information indicating a degree of the deviation.

The information indicating the degree of the deviation represents the degree of a change in an operation required to synchronize the operation of the first user and the operation of the second user with each other. Therefore, the operation information providing apparatus of this application example is effective as an assistant for synchronizing the operation of the first user and the operation of the second user with each other.

### APPLICATION EXAMPLE 3

In the operation information providing apparatus according to the application example, the output unit may start outputting the information in a case where it is detected that the first user and the second user perform a predetermined operation, by using the outputs of the first sensor and the second sensor.

Therefore, for example, the output unit can omit the output of the information in a case where the first user and the second user do not start a predetermined operation.

### APPLICATION EXAMPLE 4

In the operation information providing apparatus according to the application example, the processor may detect the deviation on the basis of a phase difference between a signal indicating changes in the output of the first sensor with time and a signal indicating changes in the output of the second sensor with time.

Therefore, the processor can detect a deviation by the phase difference.

### APPLICATION EXAMPLE 5

In the operation information providing apparatus according to the application example, the processor may use a cycle of the repetitive operation for detection of the phase difference.

Therefore, the processor can accurately detect the phase difference even when the phase difference is conspicuously greater than the cycle of the operations.

### APPLICATION EXAMPLE 6

In the operation information providing apparatus according to the application example, the processor may perform correlation computational calculation on the signal indicating changes in the output of the first sensor with time and the signal indicating changes in the output of the second sensor with time to thereby detect the phase difference.

Therefore, the processor can accurately detect the phase difference even when the processor uses a signal for a short period of time.

### APPLICATION EXAMPLE 7

In the operation information providing apparatus according to the application example, the operation of the first user and the operation of the second user may be operations accompanied by movements of the first user and the second user, and the output unit may further output information indicating a deviation of a movement direction of the first user or the second user from a predetermined direction.

There is a possibility that a deviation of the movement direction of the first user or the second user has a relationship with the synchronization of both the users. Therefore, the information, indicating the deviation of the movement direction from the predetermined direction, being output by the output unit is effective as an assistant for synchronizing the operation of the first user and the operation of the second user with each other.

### APPLICATION EXAMPLE 8

In the operation information providing apparatus according to the application example, the operation of the first user and the operation of the second user may be rowing operations in a boat race.

Therefore, the operation information providing apparatus of this application example is effective when a boat race is improved by synchronizing a rowing operation of the first user and a rowing operation of the second user with each other.

### APPLICATION EXAMPLE 9

In the operation information providing apparatus according to the application example, the first sensor and the second sensor may be inertia sensors.

An output of the inertia sensor objectively indicates the movement of the first user and the second user. Therefore, the operation information providing apparatus is effective as an assistant for accurately synchronizing the operation of the first user and the operation of the second user with each other.

### APPLICATION EXAMPLE 10

An operation information providing system according to this application example of the invention provides information regarding a repetitive operation which is synchronously performed by a first user and a second user, and includes a first sensor, a second sensor, and an operation information providing apparatus including a processor that detects a deviation of a timing of an operation of the second user based on a timing of an operation of the first user by using an output of the first sensor detecting the operation of the first user and an output of the second sensor detecting the operation of the second user, and an output unit that outputs information indicating a state of the deviation of a case where the deviation is detected.

### APPLICATION EXAMPLE 11

The operation information providing system according to the application example may further include a notification device that notifies the second user of the information indicating the state.

According to this notification device, the second user can be notified of the state of the deviation of the operation of the second user based on the operation of the first user, and thus the second user can easily ascertain the state of his or her own deviation. Therefore, the operation information providing system may serve as an effective assistant for synchronizing the second user with the first user.

### APPLICATION EXAMPLE 12

In the operation information providing system according to the application example, the notification device may notify the second user of the information indicating the state in accordance with at least one of a color, a sound, a vibration, an image, a color change pattern, a sound change pattern, a vibration change pattern, and an image change pattern.

Therefore, the second user can intuitively ascertain whether his or her own operation precedes or lags behind the operation of the first user.

### APPLICATION EXAMPLE 13

In the operation information providing system according to the application example, there maybe a difference in at least one of a color, a sound, a vibration, an image, a color change pattern, a sound change pattern, a vibration change pattern, and an image change pattern, which are used for the notification, between a case where the deviation is positive and a case where the deviation is negative.

Therefore, the second user can obtain different sensations in a case where his or her own operation precedes the operation of the first user and in a case where his or her own operation lags behind the operation of the first user.

### APPLICATION EXAMPLE 14

In the operation information providing system according to the application example, the second sensor may be integrally formed with the notification device.

Therefore, the second user easily carries or wears the second sensor and the notification device, for example, as compared to a case where the second sensor and the notification device are formed separately from each other.

### APPLICATION EXAMPLE 15

In the operation information providing system according to the application example, one of the second sensor and the first sensor may be integrally formed with the operation information providing apparatus.

Therefore, it is possible to reduce the number of devices constituting the operation information providing system.

### APPLICATION EXAMPLE 16

An operation information providing method according to this application example of the invention provides information regarding a repetitive operation which is synchronously performed by a first user and a second user, and includes detecting a deviation of a timing of an operation of the second user based on a timing of an operation of the first user by using an output of a first sensor detecting the operation of the first user and an output of a second sensor detecting the operation of the second user, and outputting information indicating a state of the deviation of a case where the deviation is detected.

### APPLICATION EXAMPLE 17

An operation information providing program according to this application example of the invention provides information regarding a repetitive operation which is synchronously performed by a first user and a second user, and causes a computer to execute steps of detecting a deviation of a timing of an operation of the second user based on a timing of an operation of the first user by using an output of a first sensor detecting the operation of the first user and an output of a second sensor detecting the operation of the second user, and outputting information indicating a state of the deviation of a case where the deviation is detected.

### APPLICATION EXAMPLE 18

A recording medium according to this application example of the invention records an operation information providing program that provides information regarding a repetitive operation which is synchronously performed by a first user and a second user. The operation information providing program causes a computer to execute steps of detecting a deviation of a timing of an operation of the second user based on a timing of an operation of the first user by using an output of a first sensor detecting the operation of the first user and an output of a second sensor detecting the operation of the second user, and outputting information indicating a state of the deviation of a case where the deviation is detected.

### BRIEF DESCRIPTION OF THE DRAWINGS

The invention will be described with reference to the accompanying drawings, wherein like numbers reference like elements.

FIG. 1 is a diagram illustrating an outline of an operation information providing system which is applied to a boat race.

FIG. 2 is a diagram illustrating an example of a configuration of the operation information providing system.

FIG. 3A is a graph illustrating an example of two pieces of sensing data Y1 and Y2 which are targets for correlation computational calculation, and FIG. 3B is a graph illustrating a relationship between a shift amount and a correlation value of correlation computational calculation (an example in which a phase of a change waveform of the data Y2 precedes a phase of a change waveform of the data Y1).

FIG. 4A is a graph illustrating an example of two pieces of sensing data Y1 and Y2 which are targets for correlation computational calculation, and FIG. 4B is a graph illustrating a relationship between a shift amount and a correlation value of correlation computational calculation (an example in which a phase of a change waveform of the data Y2 lags behind a phase of a change waveform of the data Y1).

FIG. 5A is a graph illustrating an example of two pieces of sensing data Y1 and Y2 which are targets for correlation computational calculation, and FIG. 5B is a graph illustrating a relationship between a shift amount and a correlation value of correlation computational calculation (an example in which a phase of a change waveform of the data Y2 conspicuously precedes a phase of a change waveform of the data Y1).

FIG. 6 is a schematic flow chart illustrating a communication procedure between a master and each slave.

FIG. 7 illustrates an example of a format of sensing data.

FIG. 8 illustrates an example of a flowchart related to a first process performed by a master.

FIG. 9 illustrates an example of a flowchart related to a second process performed by a master.

FIG. 10 illustrates an example of a flow chart related to a third process performed by a master.

FIG. 11 illustrates an example of a flow chart related to a first process performed by a slave.

FIG. 12 illustrates an example of a flow chart related to a second process performed by a slave.

FIG. 13 illustrates an example of a flow chart related to a third process performed by a slave.

FIG. 14 illustrates an example of a notification method using a head mounted display (HMD) (an example of a notification given to a rower who lags behind).

FIG. 15 illustrates an example of a notification method using an HMD (an example of a notification given to a rower who proceeds).

FIG. 16 illustrates an example of a notification method using an HMD (an example of a notification given to a stroke rower).

FIG. 17 illustrates an example of a notification method using an HMD (an example of a notification given to a cox).

FIG. 18 is a diagram illustrating an outline of a modification example of the operation information providing system.

### DESCRIPTION OF EXEMPLARY EMBODIMENTS

Hereinafter, preferred embodiments of the invention will be described in detail with reference to the accompanying drawings. Meanwhile, the embodiments to be described hereinafter do not unreasonably limit the contents of the invention described in the appended claims. In addition, all configurations to be described hereinafter are not limited to being essential constituent requirements of the invention. Hereinafter, an example of an operation information providing system applied to a boat race will be described.

### 1. Operation Information Providing System

### 1-1. Outline of Operation Information Providing System

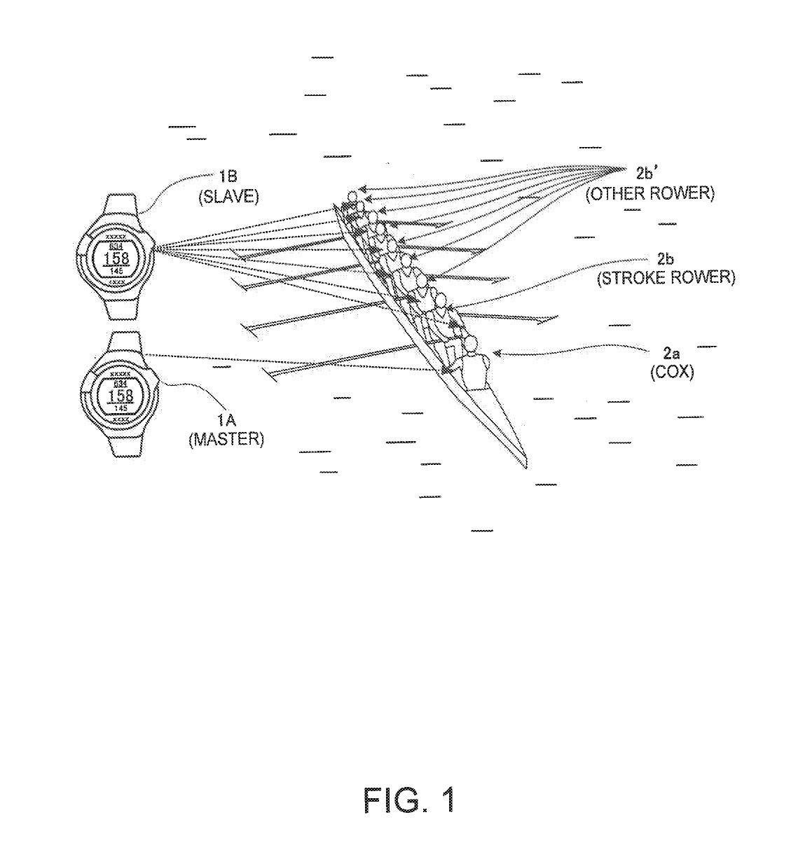

FIG. 1 is a diagram illustrating an outline of an operation information providing system which is applied to a boat race.

As illustrated in FIG. 1, the operation information providing system (hereinafter, simply referred to as a “system”) of this embodiment is applied to a boat race or the practice thereof. The operation information providing system includes an information terminal 1A (hereinafter, referred to as a “master”) as a master device and an information terminal 1B (hereinafter, referred to as a “slave”) as a slave device. Here, the number of masters 1A is one, and the number of slaves 1B is the same as, for example, the number of rowers (eight in FIG. 1).

The master 1A is worn on, for example, a body (wrist or the like) of a steersman (cox 2a). The master 1A is equipped with a function of notifying the cox 2a of information regarding all crews (the master 1A is an example of an operation information providing apparatus).

Eight slaves 1B are individually worn on rowers' bodies (wrists or the like). The individual slaves 1B are basically equipped with a function of notifying the rowers of information regarding the rowers which are wearing destinations. Thus, the individual slaves 1B are mounted with a sensor to be described later (the sensor mounted on the slave 1B is an example of a sensor that detects a user's operation).

Here, it is preferable that a wearing destination of the slave 1B in each of the eight rowers is a portion that moves in association with the movement of an oar (rowing operation). For this reason, it is preferable that the wearing destination of the slave 1B is a rower's wrist, arm, shoulder, thigh, or the like rather than the rower's head or waist. Alternatively, the wearing destination of the slave 1B may be a handle (grip) portion of an oar rather than a rower's body, or may be a pedal operating in association with an oar. Incidentally, when the slave 1B is configured as a wrist type, a wearing direction with respect to a wrist is fixed, and a direction with respect to an oar is also fixed to a direction which is determined in advance.

Here, it is assumed that both the master 1A and the slave 1B are configured as, for example, a wrist type (wristwatch type), a wearing destination of the master 1A is the wrist of the cox 2a, and a wearing destination of the slave 1B is a rower's wrist. In this case, when a rower wearing the slave 1B performs a rowing operation (an example of a repetitive operation), a particularly strong acceleration occurs in a specific direction of the slave 1B. The specific direction is, for example, a direction intersecting the center axis of an oar, and is the longitudinal direction of the rower's upper arm. Hereinafter, the slave 1B perceives the specific direction in advance.

In addition, one of the eight slaves 1B is worn on a stroke 2b who is a leader among the eight rowers (hereinafter, referred to as a “stroke rower”). Hereinafter, the rowers 2b′ other than the stroke rower 2b are called “the other rowers” or “rowers 2b′”. The slave 1B worn on the stroke rower 2b has a function of notifying the stroke rower 2b of information regarding all of the crews, and the slave 1B worn on each of the other rowers 2b′ has a function of notifying the rower 2b′ of information regarding the rower 2b′ (the stroke rower 2b is an example of a first user, and each of the rowers 2b′ is an example of a second user).

Hereinafter, it is assumed that the master 1A and the slave 1B have the same hardware configuration and are differ in only a portion of operations (a portion of application software). In addition, it is assumed that the slave 1B worn on the stroke rower 2b and the slave 1B worn on the rower 2b′ have the same hardware configuration and differ in only a portion of operations (a portion of application software).

### 1-2. Configuration of System

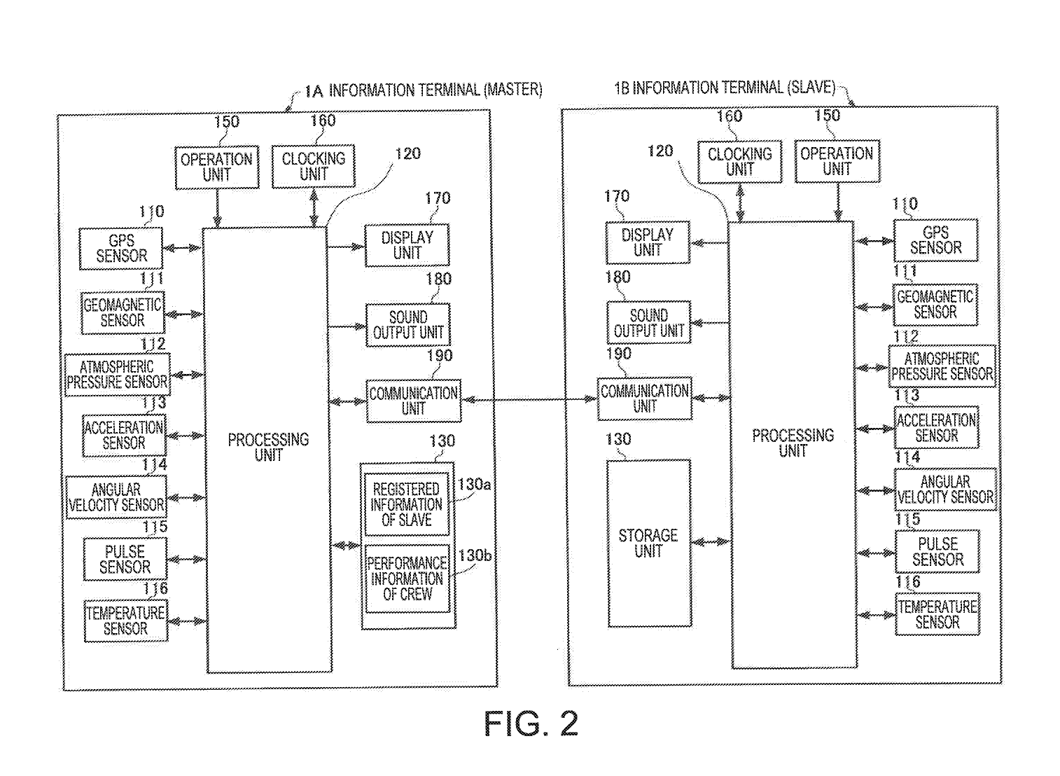

FIG. 2 is a diagram illustrating an example of a configuration of the operation information providing system. The number of slaves 1B in this system is “eight”, but only one representative slave is illustrated in FIG. 2. As illustrated in FIG. 2, a hardware configuration is common to the master 1A and the slave 1B, and the master 1A and the slave 1B can communicate with each other through, for example, short range radio communication or the like. With such a configuration, the master 1A can collect data from the eight slaves 1B. Hereinafter, the hardware configuration of the master 1A will be described, and the hardware configuration of the slave 1B will not be described because the hardware configuration is the same as the hardware configuration of the master 1A.

The master 1A is configured to include a GPS sensor 110, a geomagnetic sensor 111, an atmospheric pressure sensor 112, an acceleration sensor 113, an angular velocity sensor 114, a pulse sensor 115, a temperature sensor 116, a processing unit 120 (computer, processor), a storage unit 130, an operation unit 150, a clocking unit 160, a display unit 170 (an example of an output unit), a sound output unit 180 (an example of an output unit), a communication unit 190 (an example of an output unit), and the like. However, the master 1A may be configured such that a portion of the components is deleted or changed, or other components (for example, a humidity sensor, an ultraviolet sensor, or the like) are added.

The GPS sensor 110 is a sensor that generates positioning data indicating the position of the master 1A, or the like (data such as the latitude, the longitude, the altitude, or a velocity vector) and outputs the generated positioning data to the processing unit 120, and is configured to include, for example, a global positioning system (GPS) receiver and the like. The GPS sensor 110 receives electromagnetic waves in a predetermined frequency band which come from the outside by a GPS antenna not shown in the drawing, extracts a GPS signal from a GPS satellite, and generates positioning data indicating the position of the information terminal 1, and the like on the basis of the GPS signal.

The geomagnetic sensor 111 is a sensor that detects a geomagnetic vector indicating a direction of the Earth's magnetic field which is seen from the master 1A, and generates geomagnetic data indicating, for example, magnetic flux densities in three axial directions perpendicular to each other. Examples of the geomagnetic sensor 111 to be used include a magnet resistive (MR) element, a magnet impedance (MI) element, a hall element, and the like.

The atmospheric pressure sensor 112 is a sensor that detects ambient air pressure (atmospheric pressure), and includes, for example, a pressure sensitive element of a type that uses changes in the resonance frequency of a vibration piece (vibration type). The pressure sensitive element is a piezoelectric vibrator formed of a piezoelectric material such as quartz crystal, lithium niobate, or lithium tantalate, and examples of the pressure sensitive element to be applied include a tuning fork type vibrator, a dual tuning fork type vibrator, an AT vibrator (thickness slide vibrator), a SAW resonator, and the like. Meanwhile, an output (air pressure data) of the atmospheric pressure sensor 112 may be used in order to correct positioning data.

The acceleration sensor 113 is an inertia sensor that detects accelerations in three respective axial directions intersecting each other (ideally, perpendicular to each other) and outputs digital signals (acceleration data) according to magnitudes and directions of the detected three axial accelerations. Meanwhile, an output of the acceleration sensor 113 maybe used in order to correct information regarding a position included in the positioning data of the GPS sensor 110.

The angular velocity sensor 114 is an inertia sensor that detects angular velocities in three respective axial directions intersecting each other (ideally, perpendicular to each other) and outputs digital signals (angular velocity data) according to magnitudes and directions of the detected three axial angular velocities. Meanwhile, an output of the angular velocity sensor 114 maybe used in order to correct information regarding a position included in the positioning data of the GPS sensor 110.

The pulse sensor 115 is a sensor that generates a signal indicating a user's pulse and outputs the generated signal to the processing unit 120, and includes a light source, such as a light emitting diode (LED) light source, which irradiates a hypodermic blood vessel with measurement light having an appropriate wavelength, and a light receiving element that detects changes in the intensity of light generated in a blood vessel in accordance with the measurement light. Meanwhile, it is possible to measure a pulse rate (pulse rate per minute) by processing an intensity change waveform (pulse wave) of light by a known method such as frequency analysis. Meanwhile, an ultrasonic sensor that detects the contraction of a blood vessel by ultrasonic waves to thereby measure a pulse rate, a sensor that applies a weak current into a body from an electrode to thereby measure a pulse rate, or the like may be adopted as the pulse sensor 115, instead of a photoelectric sensor constituted by a light source and a light receiving element.

The temperature sensor 116 is a temperature-sensitive element that outputs a signal depending on ambient temperature (for example, a voltage depending on temperature). Meanwhile, the temperature sensor 116 may be a sensor that outputs a digital signal depending on temperature.

The processing unit 120 (processor) is constituted by, for example, a micro processing unit (MPU), a digital signal processor (DSP), an application specific integrated circuit (ASIC), or the like. The processing unit 120 performs various processing in accordance with programs stored in the storage unit 130 and various commands that are input by a user through the operation unit 150. Processes performed by the processing unit 120 include data processing performed on data generated by the GPS sensor 110, the geomagnetic sensor 111, the atmospheric pressure sensor 112, the acceleration sensor 113, the angular velocity sensor 114, the pulse sensor 115, the temperature sensor 116, the clocking unit 160, and the like, a display process of displaying an image on the display unit 170, a sound output process of outputting a sound (including vibration) to the sound output unit 180, and the like.

The storage unit 130 is constituted by, for example, one or a plurality of integrated circuit (IC) memories or the like, and includes a read only memory (ROM) storing data such as programs and a random access memory (RAM) serving as a work area of the processing unit 120. Meanwhile, the RAM also includes a non-volatile RAM (an example of a recording medium).

The operation unit 150 is constituted by, for example, buttons, keys, a microphone, a touch panel, a sound perception function (using a microphone not shown in the drawing), an action detection function (using the acceleration sensor 113 or the like), or the like, and performs a process of converting a user's instruction into an appropriate signal and transmits the converted signal to the processing unit 120.

The clocking unit 160, which is constituted by, for example, a real time clock (RTC) IC or the like, generates time data, such as year, month, day, hour, minute, and second, and transmits the generated time data to the processing unit 120.

The display unit 170 is constituted by, for example, a liquid crystal display (LCD), an organic electroluminescence (EL) display, an electrophoretic display (EPD), a touch panel type display, or the like, and displays various images in response to an instruction from the processing unit 120. Meanwhile, a head mounted display (HMD) provided separately from the master 1A can also be used as the display unit 170.

The sound output unit 180 is constituted by, for example, a speaker, a buzzer, a vibrator, or the like, and generates various sounds (including vibration) in response to an instruction from the processing unit 120.

The communication unit 190 performs a variety of controls for realizing data communication between the master 1A and the slave 1B. The communication unit 190 is configured to include a transmission and reception function corresponding to a short range radio communication standard such as Bluetooth (registered trademark) (including bluetooth low energy (BTLE)), wireless fidelity (Wi-Fi, registered trademark), Zigbee (registered trademark), NFC (near field communication), or ANT+ (registered trademark).

Meanwhile, the storage unit 130 of the master 1A stores a program (program for a master) for collecting information regarding a motion from the slave 1B. The processing unit 120 of the master 1A executes processes in accordance with the program for a master (an example of an operation information providing program).

On the other hand, the storage unit 130 of the slave 1B stores a program (program for a slave) for transmitting information regarding a motion to the master 1A. The processing unit 120 of the slave 1B executes processes in accordance with the program for a slave.

In addition, the storage unit 130 of the master 1A stores registered information 130a of a slave. The registered information 130a of the slave includes pieces of identification information (hereinafter, referred to as “slave IDs”) of eight slaves and pieces of identification information (hereinafter, referred to as “user IDs”) of rowers serving as wearing destinations of the respective slaves.

Meanwhile, the slave ID of each of the slaves 1B is transmitted to the master 1A side by pairing between each of the eight slaves 1B and the master 1A, for example, before a race or practice.

In addition, a user ID of each of the slaves 1B is manually input to each of the slaves 1B by each of eight rowers, for example, before a race or practice, and is transmitted to the master 1A side from each of the eight slaves 1B during pairing. Here, it is assumed that a user ID of a rower serving as a wearing destination of the slave 1B and information indicating whether or not the rower is the stroke rower 2b are input to each of the slaves 1B in advance by the rower wearing the slave 1B.

Therefore, the processing unit 120 of the master 1A can distinguish any of the eight slaves 1B from the other seven slaves 1B on the basis of a slave ID transmitted from the slave 1B serving as a communication opposite party when the processing unit communicates with the slave 1B. In addition, the processing unit 120 of the master 1A can also specify a user ID of a rower serving as a wearing destination of the slave 1B on the basis of the slave ID and registered information 130a of the slave.

In addition, the storage unit 130 of the master 1A stores performance information 130b of a crew. The performance information 130b of the crew includes sensing data for each rower collected (received) from the eight slaves 1B, performance data based on the sensing data, statistical data (statistical data of all of the crews) based on the sensing data or the performance data, and the like.

The sensing data received from each of the slaves 1B by the master 1A includes sensing data generated by a GPS sensor 110 of the slave 1B, sensing data generated by a geomagnetic sensor 111 of the slave 1B, sensing data generated by an atmospheric pressure sensor 112 of the slave 1B, sensing data generated by an acceleration sensor 113 of the slave 1B, sensing data generated by an angular velocity sensor 114 of the slave 1B, sensing data generated by a pulse sensor 115 of the slave 1B, and sensing data generated by a temperature sensor 116 of the slave 1B. The pieces of sensing data are stored in the performance information 130b in a state of being associated with a user ID of a rower serving as a wearing destination of the slave 1B.

Meanwhile, in this embodiment, a wearing destination of the master 1A is the cox 2a rather than being a rower, and thus the sensing data generated by the sensor of the master 1A is not directly used in processes to be described later. For this reason, a portion or all of the GPS sensor 110, the geomagnetic sensor 111, the atmospheric pressure sensor 112, the acceleration sensor 113, the angular velocity sensor 114, the pulse sensor 115, and the temperature sensor 116 in the master 1A can also be omitted.

Meanwhile, the sensor of the slave 1B worn on the stroke rower 2b is an example of a first sensor that detects the operation of a first user, and the sensor of the slave 1B worn on the other rower 2b′ is an example of a second sensor that detects the operation of a second user. In addition, sensing data transmitted by the slave 1B worn on the stroke rower 2b is an example of a signal indicating changes in the output of the first sensor with time, and sensing data transmitted by the slave 1B worn on the other rower 2b′ is an example of a signal indicating changes in the output of the second sensor with time.

In addition, a display unit 170 and a sound output unit 180 of the slave 1B worn on the rower 2b′ are examples of notification devices. That is, in the system of this embodiment, the second sensor detecting the operation of the second user (rower 2b′) is integrally formed with the notification devices (the display unit 170 and the sound output unit 180 of the slave 1B).

### 1-3. Correlation Computational Calculation

The processing unit 120 of the master 1A provides information regarding a rowing operation of the rower 2b′ (an example of a repetitive operation which is synchronously performed) based on the stroke rower 2b by using the pieces of sensing data received from the eight slaves 1B. Hereinafter, it is assumed that acceleration data is used as sensing data for generating information regarding a rowing operation (an example of a signal indicating changes in the output of a sensor with time). In addition, it is assumed that the following process is performed for each of seven rowers 2b′.

First, the processing unit 120 of the master 1A detects the presence or absence of a deviation and a direction of the deviation (time-series anteroposterior relation which is equivalent to precedence or lag therebetween) between a timing of a rowing operation of the stroke rower 2b and a timing of a rowing operation of the rower 2b′ by using sensing data indicating a rowing operation of the stroke rower 2b and sensing data indicating a rowing operation of the rower 2b′ (an example of processing of the processor).

In a case where a deviation between the timing of the rowing operation of the stroke rower 2b and the timing of the rowing operation of the rower 2b′ is detected, the communication unit 190 of the master 1A outputs information regarding a direction and magnitude of the deviation to the slave 1B worn on the rower 2b′ (an example of processing of the output unit).

In addition, the processing unit 120 of the master 1A performs the processing of correlation computational calculation on the sensing data of the stroke rower 2b and the sensing data of the rower 2b′ in order to detect the direction and magnitude of the deviation between the rowing operation of the stroke rower 2b and the rowing operation of the rower 2b′.

Hereinafter, the correlation computational calculation will be described. Here, it is assumed that the sensing data of the stroke rower 2b and the sensing data of the rower 2b′ are pieces of time-series data generated at a predetermined time interval (a predetermined sampling cycle).

In the correlation computational calculation, a correlation value between the sensing data of the stroke rower 2b and the sensing data of the rower 2b′ while shifting a waveform of the sensing data of the rower 2b′ in a time direction with respect to a waveform of the sensing data of the stroke rower 2b, and a shift amount for setting the correlation value to be a peak is calculated as a deviation of the rowing operation of the rower 2b′ based on the rowing operation of the stroke rower 2b.

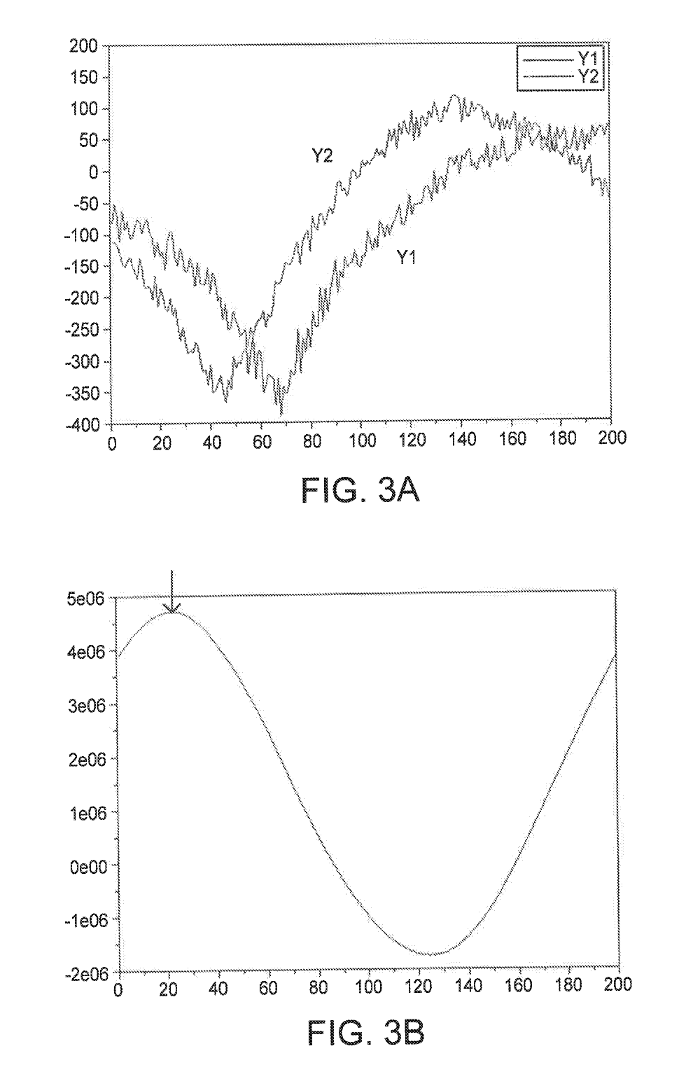

FIG. 3A is a graph illustrating an example of two pieces of sensing data Y1 and Y2 which are targets for correlation computational calculation, and FIG. 3B is a graph illustrating a relationship between a shift amount and a correlation value of correlation computational calculation (an example in which a phase of a change waveform of the data Y2 precedes a phase of a change waveform of the data Y1). In FIG. 3A, a horizontal axis represents a time, and a vertical axis represents a value of sensing data. In FIG. 3B, a horizontal axis represents the number of samplings, and a vertical axis represents a correlation value.

As illustrated in FIG. 3A, in an example in which the phase of the sensing data Y2 precedes the phase of the sensing data Y1, the correlation value is set to be a peak when the shift amount corresponds to 20 samplings, for example, as indicated by an arrow in FIG. 3B, and thus a “time of +20 samplings” is calculated as a deviation.

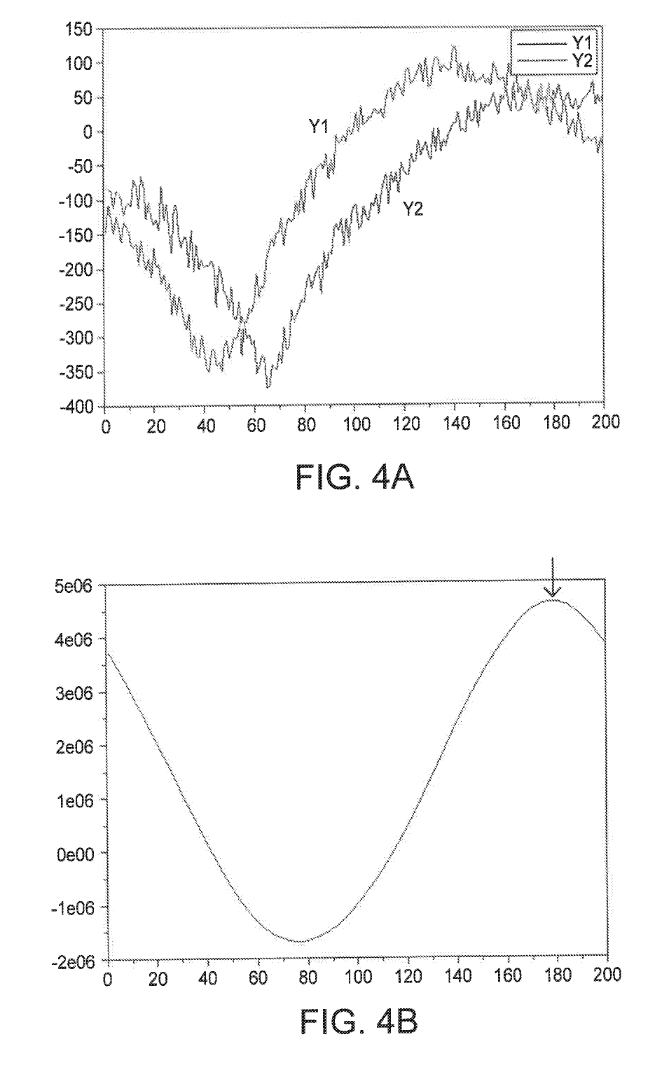

FIG. 4A is a graph illustrating an example of two pieces of sensing data Y1 and Y2 which are targets for correlation computational calculation, and FIG. 4B is a graph illustrating a relationship between a shift amount and a correlation value of correlation computational calculation (a case where a phase of a change waveform of the data Y2 lags behind a phase of a change waveform of the data Y1). In FIG. 4A, a horizontal axis represents a time, and a vertical axis represents a value of sensing data. In FIG. 4B, a horizontal axis represents the number of samplings, and a vertical axis represents a correlation value.

As illustrated in FIG. 4A, in a case where the phase of the sensing data Y2 lags behind the phase of the sensing data Y1, the correlation value is set to be a peak when the shift amount corresponds to 180 samplings, for example, as indicated by an arrow in FIG. 4B. However, the shift amount of 180 samplings is larger than 100 samplings corresponding to a half cycle of changes in the sensing data Y1 and Y2, and thus 180 samplings are folded back by one cycle (200 samplings). Accordingly, 180−200=−20, that is, a “time of −20 samplings” is calculated as a deviation.

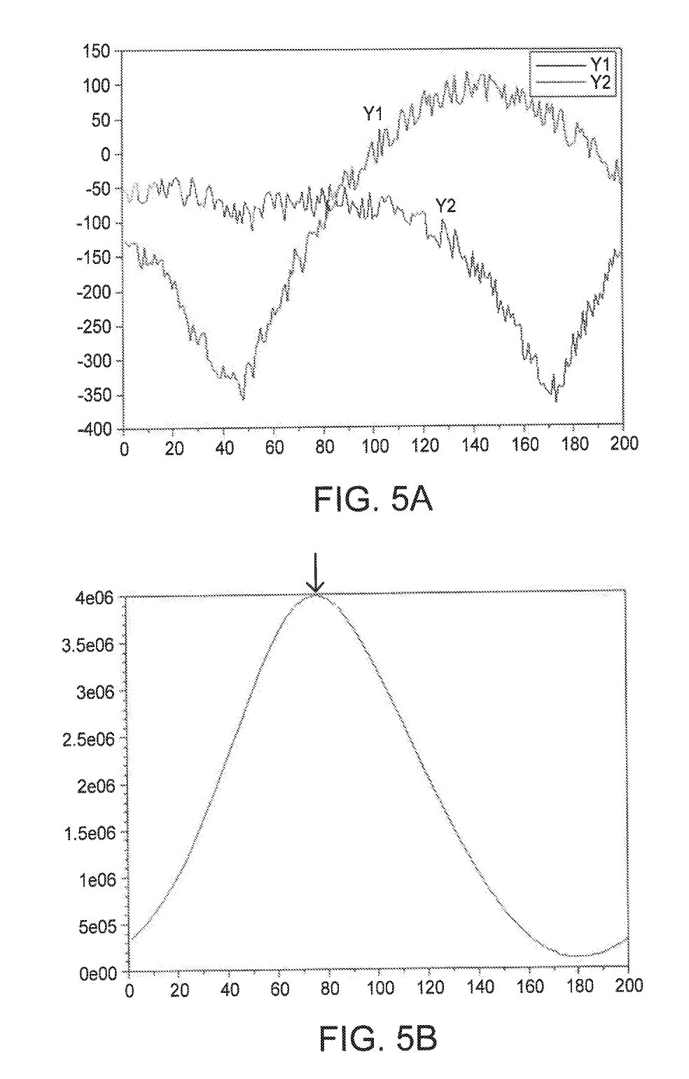

FIG. 5A is a graph illustrating an example of two pieces of sensing data Y1 and Y2 which are targets for correlation computational calculation, and FIG. 5B is a graph illustrating a relationship between a shift amount and a correlation value of correlation computational calculation (an example in which a phase of a change waveform of the data Y2 conspicuously precedes a phase of a change waveform of the data Y1). In FIG. 5A, a horizontal axis represents a time, and a vertical axis represents a value of sensing data. In FIG. 5B, a horizontal axis represents the number of samplings, and a vertical axis represents a correlation value.

As illustrated in FIG. 5A, in an example in which the phase of the sensing data Y2 conspicuously precedes the phase of the sensing data Y1, the correlation value is set to be a peak when the shift amount corresponds to 70 samplings, for example, as indicated by an arrow in FIG. 5B, and thus a “time of +70 samplings” is calculated as a deviation.

Meanwhile, the processing unit 120 of the master 1A measures the number of samplings equivalent to a cycle of changes in the sensing data Y1 and Y2 (1 pitch of a rowing operation, an example of a cycle of a repetitive operation, and hereinafter referred to as a “pitch of rowing” or a “pitch”), prior to the correlation computational calculation.

The measurement of a pitch of rowing can be performed, for example, by fast Fourier transform (FFT) with respect to sensing data of the stroke rower 2b which has a data length equal to or greater than a fixed length. Specifically, the processing unit 120 of the master 1A performs FFT on sensing data whenever the processing unit receives the sensing data of the stroke rower 2b, to thereby calculate a pitch of rowing. The processing unit 120 of the master 1A always uses the latest pitch of rowing for correlation computational calculation with respect to each rower 2b′. Hereinafter, it is assumed that the pitch of rowing is 200 samplings.

The processing unit 120 of the master 1A performs a process of subtracting the number of samplings (200) equivalent to the pitch of rowing from the value of the deviation, as the above-mentioned folding-back process in a case where the deviation calculated by the correlation computational calculation is larger than a half cycle (here, 100 samplings).

Therefore, the deviation calculated by the correlation computational calculation accurately indicates whether or not there is a deviation of a timing of a rowing operation of the rower 2b′ based on the rowing operation of the stroke rower 2b and the state of the deviation, that is, positive and negative (distinguishment between lag and precedence).

Meanwhile, the processing unit 120 of the master 1A uses FFT in order to measure a pitch of rowing, but may detect a timing at which the size of sensing data (acceleration data) exceeds a predetermined threshold value and may specify a pitch of rowing on the basis of a cycle of occurrence of the timing.

### 1-4. Communication Between Master and Each Slave

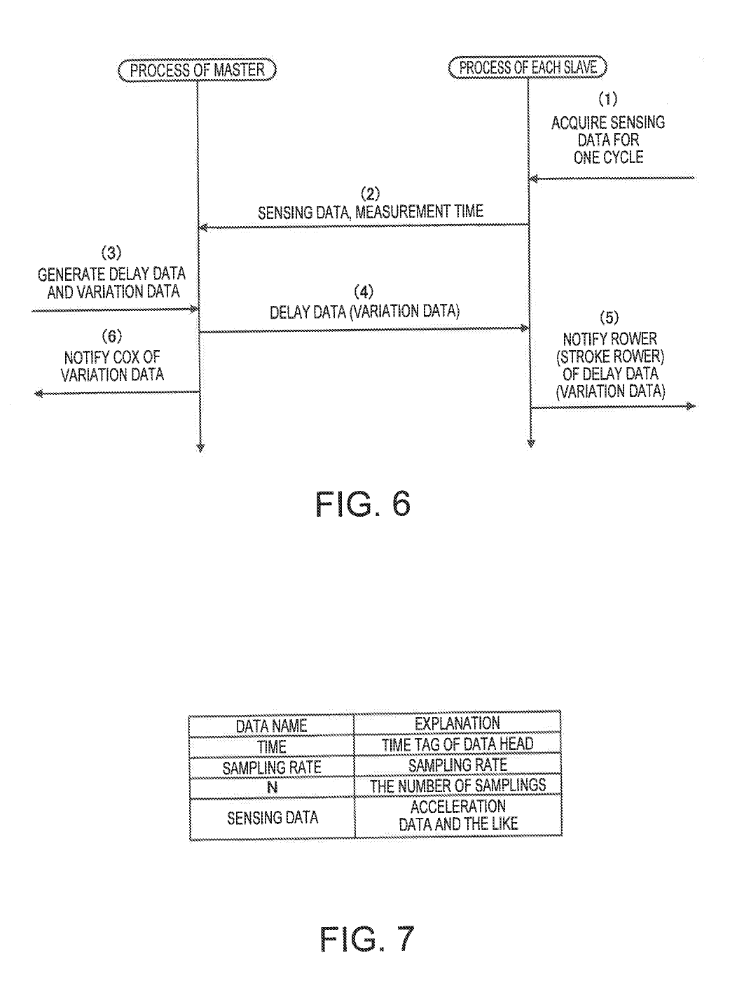

FIG. 6 is a schematic flow chart illustrating a communication procedure between a master and each slave. Meanwhile, the number of slaves 1B is set to “1” in FIG. 6, but is actually “8”. Accordingly, the master 1A communicates with each of the eight slaves 1B by the communication procedure illustrated in FIG. 6.

The master 1A and the eight slaves 1B repeat the following communication process for each rowing pitch or for each plurality of pitches.

(1) First, when the processing unit 120 of each of the eight slaves 1B acquires sensing data of one pitch, the processing units generate the sensing data having a measurement time and a slave ID attached thereto in a predetermined format.

(2) The processing unit 120 of each of the eight slaves 1B transmits the sensing data toward the master 1A through the communication unit 190 of the slave (slave 1B).

(3) When the processing unit 120 of the master 1A receives sensing data from the communication unit 190 of each of the slaves 1B through the communication unit 190 of the master 1A, the processing unit generates delay data (an example of information indicating the state of a deviation), which indicates a deviation (having a positive or negative sign attached thereto) in a rowing operation of each of the seven rowers 2b′ based on the stroke rower 2b, for each rower 2b′ and generates variation data indicating the distribution of deviations of the seven rowers 2b′ based on the stroke rower 2b. Meanwhile, the delay data is data for each rower 2b′, while the variation data is data of all of the rowers.

(4) Next, the processing unit 120 of the master 1A individually transmits the pieces of delay data for the respective seven rowers 2b′ to the slaves 1B of the seven rowers 2b′ in a predetermined format. In addition, the processing unit 120 of the master 1A transmits variation data to the slave 1B of the stroke rower 2b in a predetermined format.

However, in a case where at least one of the pieces of delay data is zero, the processing unit 120 of the master 1A omit transmission to the rower 2b′ corresponding to the delay data being zero. In addition, the transmission of data from the processing unit 120 of the master 1A to the slave 1B is performed through the communication unit 190 of the master 1A and the communication unit 190 of the slave 1B.

(5) Next, when the slave 1B of the rower 2b′ receives delay data addressed to the device, the slave notifies the rower 2b′ of the delay data. On the other hand, when the slave 1B of the stroke rower 2b receives variation data addressed to the device, the slave notifies the stroke rower 2b of the variation data.

Meanwhile, the notification of the delay data (an example of information indicating the state of a deviation) is given to the rower 2b′ through at least one of the display unit 170 and the sound output unit 180 of the slave 1B worn on the rower 2b′. In addition, the information notified to the rower 2b′ may be the value of the deviation included in the delay data, but may be only a direction (positive or negative) of the deviation. In this case, the rower 2b′ can sequentially ascertain whether its own rowing operation runs ahead of or behind that of the stroke rower 2b. In addition, the notification is given to the rower 2b′ by at least one of various notification formats such as a color, a sound, vibration, a shape (shape of an image, such as a mark, a character string, which is displayed), a color change pattern, a sound change pattern, a vibration change pattern, and a shape change pattern. In addition, it is assumed that there is a difference in at least one of a color, a sound, vibration, a shape, a color change pattern, a sound change pattern, a vibration change pattern, and a shape change pattern between a case where the value of the deviation included in the delay data is positive and a case where the value of the deviation included in the delay data is negative (an example in which a difference is provided).

For example, a notification may be given using one (for example, a color) of a plurality of notification formats in a case where the value of the deviation is positive, and a notification may be given in a notification format (for example, a sound) in a case where the value of deviation is negative, which is different from that in a case where the value of the deviation is positive. In addition, a first combination of notification formats (for example, a sound and vibration) maybe used in a case of being positive, and a second combination of notification formats (for example, a sound, a shape, and the like), which is different from the first combination of notification formats, maybe used in a case of being negative. In addition, different notification methods using the same notification format may be performed. For example, a notification is given by a change pattern of a different color (red, blue, or the like), a different sound (a high sound, a low sound, or the like), a different mark or character, or a different color in a case of being positive and a case of being negative.

In addition, a notification of variation data is given to the stroke rower 2b through at least one of the display unit 170 and the sound output unit 180 of the slave 1B worn on the stroke rower 2b. In addition, a notification is given to the stroke rower 2b by at least one of a color, a sound, vibration, a shape (a mark or a character string, and including a size), a color change pattern, a sound change pattern, a vibration change pattern, and a shape change pattern.

(6) On the other hand, the processing unit 120 of the master 1A notifies the cox 2a of variation data. The notification of the variation data is given to the cox 2a through at least one of the display unit 170 and the sound output unit 180 of the master 1A. In addition, the notification is given to the cox 2a by at least one of a color, a sound, vibration, a shape (a mark or a character string, and including a size), a color change pattern, a sound change pattern, a vibration change pattern, and a shape change pattern.

Therefore, the cox 2a and the stroke rower 2b can sequentially ascertain variations in a rowing operation of the seven rowers 2b′ based on a rowing operation of the stroke rower 2b during a race or practice, and each of the seven rowers 2b′ can sequentially ascertain whether or not his or her own rowing operation based on a rowing operation of the stroke rower 2b progresses and the degree of the rowing operation during a race or practice.

### 1-5. Format of Sensing Data

FIG. 7 illustrates an example of a format of sensing data which is transmitted toward the master 1A from the slave 1B. As illustrated in FIG. 7, in addition to sensing data, a time (time tag), a sampling rate, and the number of samplings (the number of samplings as mentioned herein is the number of samplings of sensing data transmitted) are added to the transmitted sensing data. Although not shown in FIG. 7, a user ID corresponding to the sensing data, and the like are added to the sensing data.

The “sensing data” in FIG. 7 includes at least acceleration data generated in a specific direction of the slave 1B. The specific direction is a direction in which the movement of an oar which is associated with a rowing operation is most strongly reflected, as described above. The sensing data is generated on the basis of the output of the acceleration sensor 113 mounted to the slave 1B by processing unit 120 of the slave 1B.

The “time” in FIG. 7 may be time data generated by the clocking unit 160 of the slave 1B, but is preferably time data (time stamp) which is included in positioning data generated by the GPS sensor 110. In this case, the master 1A can accurately synchronize the pieces of sensing data individually received from the eight slaves 1B (can make times conform to each other) on the basis of the time data.

Meanwhile, the format of the sensing data is not limited to that illustrated in FIG. 7 as long as the format is determined in advance between the slave 1B and the master 1A.

In addition, the “sensing data” in FIG. 7 may include at least one of angular velocity data, positioning data, geomagnetic data, air pressure data, pulse data (an output of the pulse sensor 115), and temperature data (an output of the temperature sensor 116), in addition to the acceleration data. The performance information 130b (see FIG. 2) is generated on the basis of various pieces of sensing data for respective rowers which are collected from the eight slaves 1B by the master 1A

### 1-6. First Process Performed by Master

When the master 1A and the eight slaves 1B are turned on and a race or practice is started, the master 1A and the eight slaves 1B automatically start measurement. Meanwhile, a timing when the measurement is started is controlled on the basis of a measurement flag held by the master 1A and a measurement flag held by the slave 1B. However, a flow regarding the control of the measurement flags will be described later, and a process (first process) other than the control of a flag will be first described.

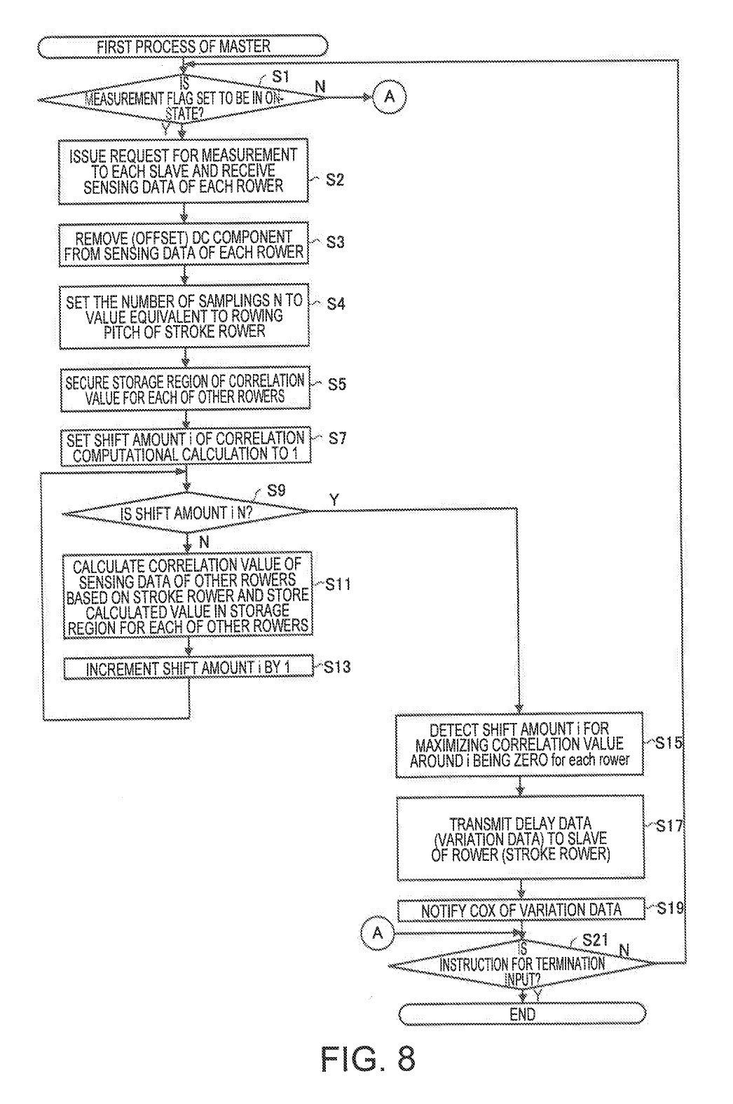

FIG. 8 illustrates an example of a flowchart related to a first process (an example of an operation information providing method) which is performed by a master.

First, the processing unit 120 of the master 1A determines whether or not a measurement flag of the device is set to be in an on-state (S1). The processing unit proceeds to the determination of termination (S21) in a case where the measurement flag is not set to be in an on-state (S1N), and starts preprocessing (S2 to S7) of correlation computational calculation in a case where the measurement flag is set to be in an on-state (S1Y).

In the preprocessing (S2) of the correlation computational calculation, the processing unit 120 of the master 1A first issues a request for measurement to each of the eight slaves 1B, and receives pieces of sensing data of the eight rowers from the eight slaves 1B (S2).

Next, the processing unit 120 of the master 1A removes DC components (direct current components, offset components) from the pieces of sensing data of the eight rowers (S3). Meanwhile, in this step, processing such as noise elimination, calibration, or the like with respect to the pieces of sensing data of the eight rowers may be performed.

Next, the processing unit 120 of the master 1A sets a maximum value (the number of samplings N) of a shift amount i in the correlation computational calculation (described above) to a value equivalent to a pitch of rowing (cycle of a rowing operation) of the stroke rower 2b (S4). A method of calculating a pitch of rowing is as described above. However, in a case where a pitch of rowing has not been calculated at a point in time when this step S4 is performed, it is assumed that the number of samplings N is set to a predetermined value (or a previous value).

Next, the processing unit 120 of the master 1A secures a storage region of a correlation value on the storage unit 130 (S5). The securement of the region is performed for each rower 2b′.

Next, the processing unit 120 of the master 1A sets the shift amount i of the correlation computational calculation to an initial value “1” (S7), and proceeds to processes (S11, S13) of the correlation computational calculation. Meanwhile, a unit of the shift amount i is the number of samplings.

Next, the processing unit 120 of the master 1A repeats a correlation value calculation process (S11) until the shift amount i reaches N (S9N) while incrementing the shift amount i by 1 (S13). This calculation process is performed for each rower 2b′.

In the correlation value calculation process (S11), the processing unit 120 of the master 1A calculates a correlation value of sensing data of the rower 2b′ based on the stroke rower 2b for each rower 2b′ and stores the calculated correlation value in a storage region for each rower 2b′. Meanwhile, the correlation value can be obtained by the following expression.

$${\sum }_{k = 1}^{N} {Y}_{1} ( k ) {Y}_{2} ( k + 1 mod N ) \qquad ( 1 )$$

Here, Y₁ denotes sensing data of the stroke rower 2b, and Y₂ denotes sensing data of the rower 2b′.

Thereafter, in a case where the shift amount i reaches N (S7), the processing unit 120 of the master 1A starts a process of generating delay data and the like (S15 to S19).

In the process of generating delay data and the like (S15 to S19), the processing unit 120 of the master 1A detects the shift amount i for maximizing the correlation value around the shift amount i being zero, for each rower 2b′ (S15). The shift amount i is an example of a phase difference. However, the processing unit 120 of the master 1A performs the above-described folding-back process in a case where the shift amount i is larger than a half pitch of rowing.

Next, the processing unit 120 of the master 1A generates delay data for each rower 2b′ and variation data of all of the rowers, transmits the delay data for each rower 2b′ to the slaves 1B of the rowers 2b′, and transmits the variation data to the slave 1B of the stroke rower 2b (S17). Thereafter, each of the slaves 1B of the rowers 2b′ and the slave 1B of the stroke rower 2b performs the above-described notification. This notification is as described above.

Next, the processing unit 120 of the master 1A notifies the cox 2a of the variation data (S19). This notification is as described above.

The processing unit 120 of the master 1A repeats the above-described processes (S2 to S19) as long as an instruction for termination is not input from the cox 2a (S21N) and the measurement flag of the device is not set to be in an off-state (S1Y).

On the other hand, the processing unit 120 of the master 1A stands by without performing the above-described processes (S2 to S19) in a case where the measurement flag is set to be in an off-state (S1N), and terminates the flow in a case where an instruction for termination is input from the cox 2a (S21Y).

### 1-7. Second Process Performed by Master

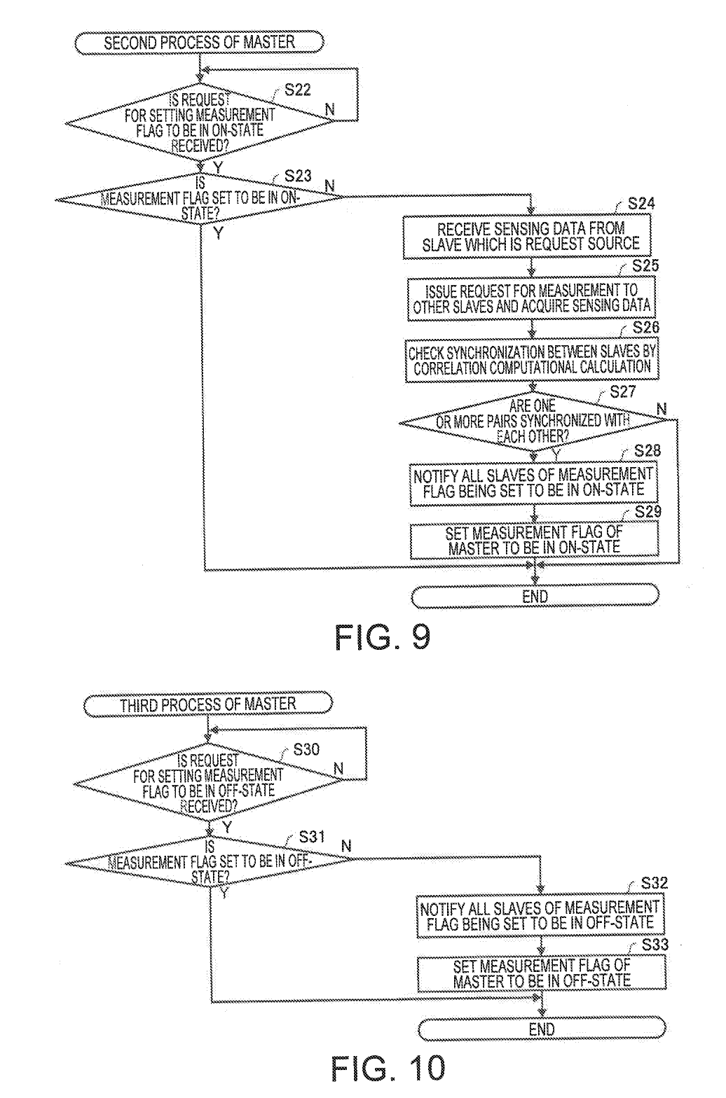

FIG. 9 illustrates an example of a flowchart related to a second process performed by a master.

The second process is a process related to an on-state of a measurement flag. For example, the second process is performed as a process performed in parallel with the above-described first process. In addition, it is assumed that the second process illustrated in FIG. 9 is repeated as long as the master 1A is turned on.

First, the processing unit 120 of the master 1A stands by until the processing unit receives a request for setting a measurement flag to be in an on-state from any of the slaves 1B (S22N).

Thereafter, the processing unit 120 of the master 1A determines whether or not a measurement flag of the device is set to be in an on-state (S23) when the processing unit receives the request for setting the measurement flag to be in an on-state from any of the slaves 1B (S22Y), terminates the flow in a case where the measurement flag has been already set to be in an on-state (S23Y), and starts a process of detecting a repetitive operation (S24 to S27) in a case where the measurement flag has not been set to be in an on-state (S23N).

In the process of detecting a repetitive operation (S24 to S27), first, the processing unit 120 of the master 1A specifies the slave 1B serving as a request source, receives sensing data from the slave 1B (S24), issues a request for measurement to slaves 1B other than the slave 1B, and collects pieces of sensing data from the slaves 1B (S25).

Next, the processing unit 120 of the master 1A performs correlation computational calculation on each of different pairs among the eight pieces of sensing data received from the respective eight slaves 1B, and determines whether or not one or more pairs have been synchronized with each other (S26). The “synchronization” as mentioned herein means that, for example, a shift amount i for setting a correlation value to a peak is less than a predetermined threshold value.

The processing unit 120 of the master 1A terminates the flow without setting the measurement flag to be in an on-state in a case where all of the pairs are not synchronized with each other (S27N), notifies (instructs) all of the slaves 1B of the measurement flag being set to be in an on-state (S28) and sets the measurement flag of the device to be in an on-state (S29) in a case where one or more pairs are synchronized with each other (S27Y), and then terminates the flow.

Here, in general, when a race or practice is started, at least one of the rowers 2b and 2b′ starts a rowing operation using an oar, and thus the determination result in step S22 is Y. In addition, when the race or practice is started, it is considered that there is a certain correlation between rowing operations of the respective rowers 2b and 2b′ even if the rowing operations do not completely conform to each other, the determination result in step S27 is Y. Therefore, according to the above-described flow, when a race or practice is started, all of the measurement flag of the master 1A and the measurement flags of the slaves 1B are set to be in an on-state.

Meanwhile, in the above-described flow, a state where all of the measurement flag of the master 1A and the measurement flags of the slaves 1B are set to be in an on-state is an example of a “case where it is detected that a first user and a second user perform a predetermined operation by using outputs of a first sensor and a second sensor”.

### 1-8. Third Process Performed by Master

FIG. 10 illustrates an example of a flow chart related to a third process performed by a master.

The third process is a process related to an off-state of a measurement flag. For example, the third process is performed as a process performed in parallel with the above-described first and second processes. In addition, it is assumed that the third process illustrated in FIG. 10 is repeated as long as the master 1A is turned on.

First, the processing unit 120 of the master 1A stands by until the processing unit receives a request for setting a measurement flag to be in an off-state from at least one slave 1B (S30N).

Thereafter, the processing unit 120 of the master 1A determines whether or not a measurement flag of the device is set to be in an off-state (S31) when the processing unit receives the request for setting the measurement flag to be in an off-state from at least one slave 1B (S31Y), terminates the flow in a case where the measurement flag has been already set to be in an off-state (S31Y), and proceeds to processes (S32 to S33) for setting the measurement flag to be in an off-state in a case where the measurement flag has not been set to be in an off-state (S31N).

Next, the processing unit 120 of the master 1A notifies (instructs) all of the slaves 1B of the measurement flag being set to be in an off-state (S32), sets the measurement flag of the device to be in an off-state (S33), and then terminates the flow.

That is, when the master 1A receives the request for setting the measurement flag to be in an off-state from at least one slave 1B, the master sets the measurement flags of all of the slaves 1B and the measurement flag of the device to be in an off-state. Thereby, the measurement of the entire system is simultaneously stopped.

### 1-9. First Process Performed by Slave

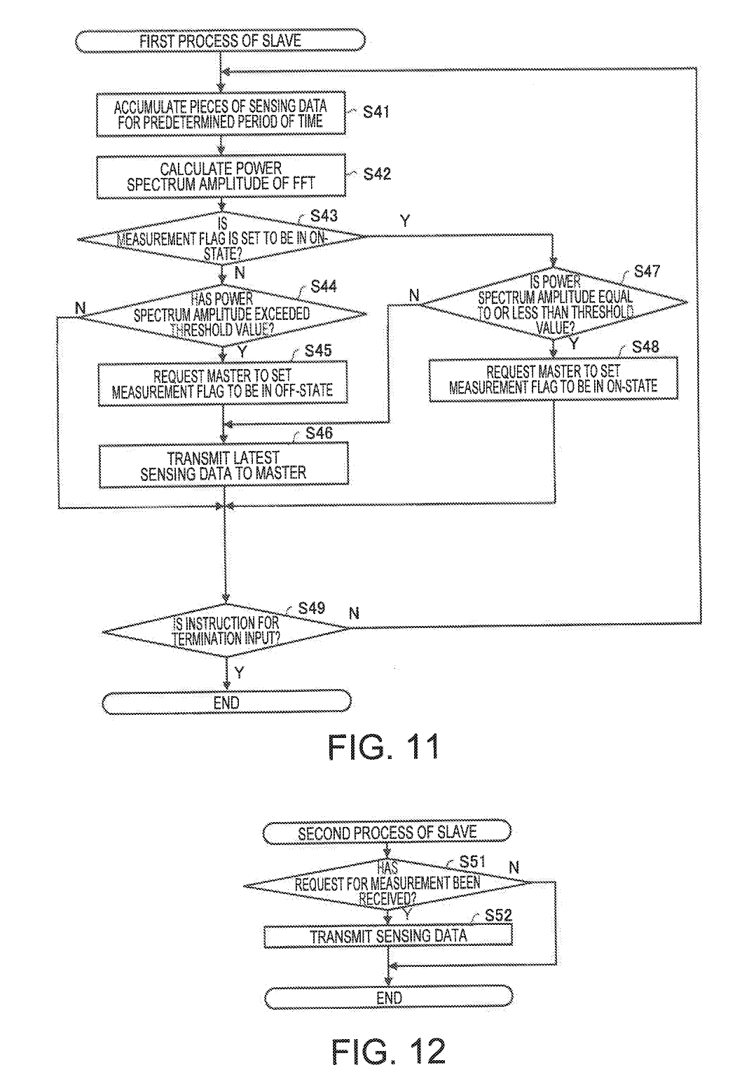

FIG. 11 illustrates an example of a flow chart related to a first process performed by a slave. This flow is performed by each of the eight slaves 1B in this system.

The first process is mainly a process which is actively performed by the slave 1B, regardless of an instruction from the master 1A. Meanwhile, a process which is passively performed by the slave 1B in response to an instruction from the master 1A will be described later (see a second process and a third process).

First, the processing unit 120 of the slave 1B accumulates pieces of sensing data for a predetermined period of time (S41). Meanwhile, this accumulation time is set, for example, for each pitch of rowing. The value of one pitch of rowing is measured by the master 1A as described above, and notice of the value is given from the master 1A to the slave 1B.

Next, the processing unit 120 of the slave 1B performs fast Fourier transform (FFT) on the accumulated sensing data to thereby calculate a power spectrum amplitude of the sensing data (S42).

Next, the processing unit 120 of the slave 1B determines whether or not a measurement flag of the device is set to be in an on-state (S43), proceeds to a first confirmation process (S44, S45) in a case where the measurement flag is not set to be in an on-state (S43N), and proceeds to a second confirmation process (S47, S48) in a case where the measurement flag is set to be in an on-state (S43Y).

In the first confirmation process (S44, S45), the processing unit 120 of the slave 1B first determines whether or not the power spectrum amplitude has exceeded a predetermined threshold value (S44), and immediately proceeds to a termination determination process (S49) in a case where the power spectrum amplitude has not exceed the predetermined threshold value (S44N). The processing unit requests the master 1A to set the measurement flag to be in an off-state (S45) and transmits the latest sensing data to the master 1A (S46) in a case where the power spectrum amplitude has exceeded the predetermined threshold value (S44Y), and then proceeds to the termination determination process (S49).

In the second confirmation process (S47, S48), the processing unit 120 of the slave 1B first determines whether or not the power spectrum amplitude is equal to or less than the predetermined threshold value (S47), proceeds to a sensing data transmission process (S46) in a case where the power spectrum amplitude is not equal to or less than the threshold value (S47N), requests the master 1A to set the measurement flag to be in an on-state (S48) in a case where the power spectrum amplitude is equal to or less than the threshold value (S47Y), and then proceeds to the termination determination process (S49).

The processing unit 120 of the slave 1B repeats the above-described process as long as an instruction for termination is not input from the rower wearing the slave 1B (S49N), and terminates the flow in a case where an instruction for termination is input from the rower (S49Y).

Therefore, the individual slaves 1B can request the master 1A to set the measurement flag to be in an on-state at a timing when rowers who are wearing destinations of the slaves 1B start a rowing operation, and can request the master 1A to set the measurement flag to be in an off-state at a timing when the rowers stop the rowing operation.

Meanwhile, it is assumed that the threshold value used in steps S44 and S47 mentioned above is set to a value equivalent to an intermediate value between a spectrum amplitude when a rower performs a rowing operation and a spectrum amplitude when the rower does not perform a rowing operation. Meanwhile, this value can be set by making the rower wearing the slave 1B actually perform a rowing operation (can be calibrated).

In step S42 mentioned above, the processing unit 120 of the slave 1B detects the start or stop of the rowing operation on the basis of the power spectrum amplitude of the sensing data, but may perform the detection on the basis of an amplitude of the sensing data (amplitude before the FFT).

In the above-described flow, the processing unit 120 of the slave 1B detects whether a rowing operation has been performed in accordance with the magnitude of a spectrum amplitude (that is, whether or not a pitch of the rowing operation is stabilized), but may detect whether or not a rowing operation has been performed in accordance with whether or not an oar has landed on the water. In this case, the processing unit 120 of the slave 1B may determine that the oar has landed on the water in a case where a characteristic pattern (characteristic pattern generated when the oar has landed on the water) which is generated in a time change waveform of sensing data.

### 1-10. Second Process Performed by Slave

FIG. 12 illustrates an example of a flow chart related to a second process performed by a slave. This flow is performed by each of the eight slaves 1B in this system.

The second process is a measurement process which is passively performed by the slave 1B in response to an instruction from the master 1A. For example, the second process is performed as a process performed in parallel with the above-described first process. In addition, it is assumed that the second process illustrated in FIG. 12 is repeated as long as the slave 1B is turned on.

As illustrated in FIG. 12, the processing unit 120 of the slave 1B determines whether or not a request for measurement has been received from the master 1A (S51), transmits the latest sensing data generated by the device to the master 1A in a case where the request has been received (S51Y), and terminates the flow without transmitting sensing data in a case where the request has not been received (S51N).

### 1-11. Third Process Performed by Slave

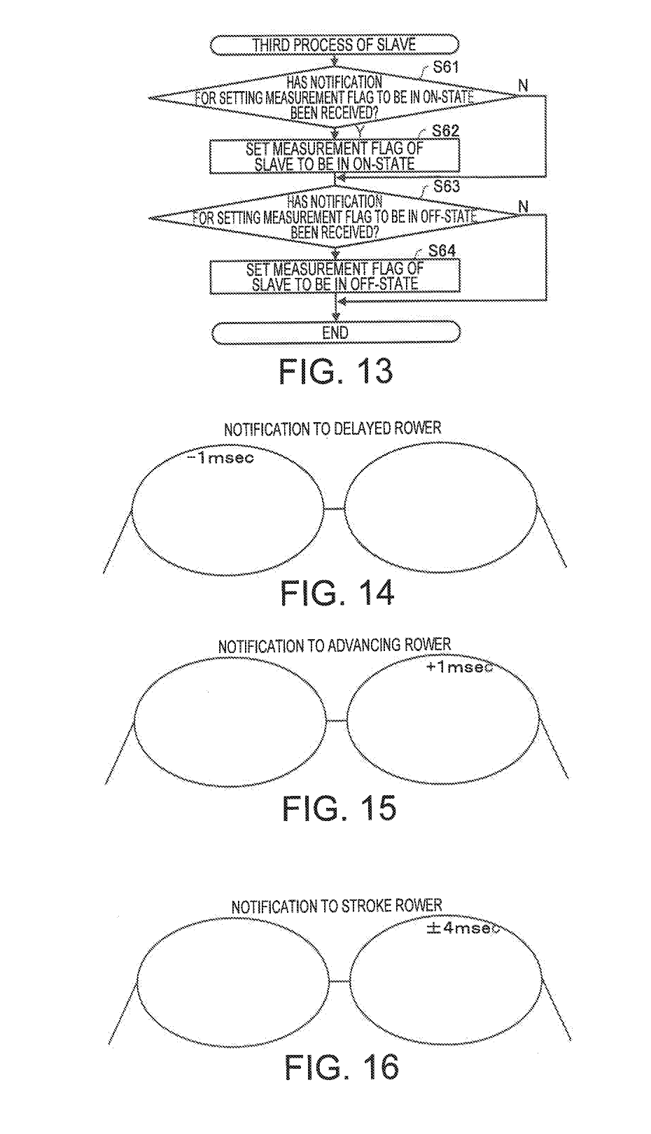

FIG. 13 illustrates an example of a flow chart related to a third process performed by a slave. This flow is performed by each of the eight slaves 1B in this system.

The third process is a process of controlling a measurement flag which is passively performed by the slave 1B in response to an instruction from the master 1A. For example, the third process is performed as a process performed in parallel with the above-described first and second processes. In addition, it is assumed that the third process illustrated in FIG. 13 is repeated as long as the slave 1B is turned on.

First, the processing unit 120 of the slave 1B determines whether or not a notification for setting a measurement flag to be in an on-state has been received from the master 1A (S61), sets a measurement flag of the device to be in an on-state (S62) in a case where the notification has been received (S61Y), and proceeds to the next process (S63) without setting the measurement flag of the device to be in an on-state in a case where the notification has not been received (S61N).

Next, the processing unit 120 of the slave 1B determines whether or not a notification for setting a measurement flag to be in an off-state has been received from the master 1A (S63), sets a measurement flag of the device to be in an off-state (S64) in a case where the notification has been received (S63Y), and terminates the flow without setting the measurement flag of the device to be in an off-state in a case where the notification has not been received (S63N).

Therefore, the slave 1B of this embodiment does not change over the measurement flag of the device as long as no notice is given from the master 1A. Therefore, in the system of this embodiment, the master 1A worn on the cox 2a can control the start and termination of measurement of the slaves 1B of all of the rowers.

Meanwhile, in FIG. 13, although the process of setting a measurement flag to be in an on-state (S61, S62) and the process of setting a measurement flag to be in an off-state (S63, S64) are configured as processes performed in series, the processes may be configured as processes performed in parallel, and it is also possible to change the order of the process of setting a measurement flag to be in an on-state and the process of setting a measurement flag to be in an off-state.

### 1-12. Operational Effects of Embodiment

As described above, the master 1A of this embodiment provides information regarding rowing operations performed by the stroke rower 2b and the other rowers 2b′. The master 1A includes the processing unit 120 that detects a deviation of a timing of a rowing operation of the other rower 2b′ based on a timing of a rowing operation of the stroke rower 2b by using an output (sensing data regarding an acceleration) of the slave 1B detecting a rowing operation of the stroke rower 2b and outputs (sensing data regarding an acceleration) of the slaves 1B detecting rowing operations of the other rowers 2b′. In addition, the master 1A includes the communication unit 190 that transmits (outputs) delay data, indicating the positive and negative of a deviation of a timing of a rowing operation of each of the other rowers 2b′ based on a timing of a rowing operation of the stroke rower 2b, to the slaves 1B of the other rowers 2b′ in a case where the deviation is detected.

Therefore, each of the other rowers 2b′ can ascertain whether a timing of its own rowing operation lags behind or precedes a timing of a rowing operation of the stroke rower 2b. Therefore, each of the other rowers 2b′ easily synchronizes its own rowing operation with the rowing operation of the stroke rower 2b. Therefore, according to the system of this embodiment, rowing operations of all of the rowers are synchronized with each other, and thus it is possible to achieve an improvement in the speed of a boat or an improvement in a crew's technique.

### 2. Modification Example

### 2-1. Modification Example Using HMD

Meanwhile, in the above-described embodiment, the cox 2a wearing the master 1A can use a head mounted display (HMD) instead of or as the display unit 170 of the master 1A. The HMD, which is a head mounted type device that projects a display screen onto the retinas of the eyes of a person serving as a wearing destination. In this case, the processing unit 120 of the master 1A can notify the cox 2a of information (here, variation data) by using the HMD. In this case, the cox 2a can confirm the information without averting his or her eyes during a race or practice.

In the above-described embodiment, the stroke rower 2b wearing the slave 1B can use an HMD instead of or as the display unit 170 of the slave 1B. In this case, the processing unit 120 of the slave 1B can notify the stroke rower 2b of information (here, variation data) by using the HMD. In this case, the stroke rower 2b can confirm the information without averting his or her eyes during a race or practice.

In the above-described embodiment, the other rowers 2b′ wearing the slaves 1B can use an HMD instead of or as the display unit 170 of the slave 1B. In this case, the processing unit 120 of the slave 1B can notify the rower 2b′ of information (here, delay data) by using the HMD. In this case, the rower 2b′ can confirm the delay data without averting his or her eyes during a race or practice.

In addition, the processing unit of the slave 1B worn on the rower 2b′ may change over at least one of a display position, a display color, a display brightness, and a shape in the HMD in accordance with a sign (positive or negative) of the delay data. For example, a display position may be changed over depending on whether the delay data is positive or negative. In FIGS. 14 and 15, delay data is displayed on the left eye side in an example in which the delay data has a negative value (here, an example in which the phase of a rowing operation is delayed), and delay data is displayed on the right eye side in an example in which the delay data is positive (here, an example in which the phase of a rowing operation is advanced). In this manner, a rower can instantaneously distinguish between a case where his or her rowing operation is delayed and a case where his or her rowing operation is advanced, by a display destination of a numerical image. Incidentally, in this embodiment, display contents are updated for each pitch of a rowing operation.

Meanwhile, FIG. 14 illustrates a state where the value (negative value) of delay data is displayed in an upper portion of a visual field of a left eye by a numerical image, and FIG. 15 illustrates a state where the value (positive value) of delay data is displayed in an upper portion of a visual field of a right eye by a numerical image. In addition, FIGS. 14 and 15 illustrate an example in which a unit of delay data is set to be [msec]. Although not shown in FIGS. 14 and 15, a display color of the numerical image may be given a difference between when the value of the delay data is a negative value and when the value of the delay data is positive. In this manner, a rower can instantaneously distinguish between a case where his or her rowing operation is delayed and a case where his or her rowing operation is advanced, by the color of the numerical image. Incidentally, in this embodiment, display contents are updated for each pitch of a rowing operation.

On the other hand, FIG. 16 illustrates an example of a state where a stroke rower is notified of variation data. FIG. 16 illustrates a state where a range from a maximum delay time to a maximum advance time in all crews is displayed as variation data by a numerical image. FIG. 16 illustrates an example in which a unit of variation data is set to be [msec].

In addition, since a possibility that the cox 2a views a distant target during a race or practice is stronger than a possibility that the cox views a near object, it is preferable that an apparent distance of a virtual image displayed in front of the eyes of the cox 2a by an HMD worn on the cox 2a is set to be an infinitely distant point (or a distance which is previously set by a crew) when seen from the eyes of the cox 2a.

On the other hand, since there is a strong possibility that the rowers 2b and 2b′ view the cox 2a during a race or practice, it is preferable that an apparent distance of a virtual image displayed in front of the eyes of the rowers 2b and 2b′ by HMDs worn on the rowers 2b and 2b′ is set to be equal to a distance to the cox 2a when seen from the rowers 2b and 2b′.

In addition, the system of this embodiment is used for sports, and thus an HMD is configured as a transmission type display. The transmission type display guides light for display without shielding much of light directed to eyes from the outside world, and thus is suitable for sports.

In addition, HMDs having various appearances can be applied, and a spectacle type display called, for example, smart glasses can also be applied.

### 2-2. With Regard to Notification Configuration

In the above-described embodiment, various configurations can be used as a mode in which a user is notified of any information. As a notification configuration, at least one of, for example, an image, light, a sound, vibration, an image change pattern, a change pattern of light, a sound change pattern, and a vibration change pattern can be used.

For example, in the above-described embodiment, in addition to a notification using an image (including a text image), various configurations such as a notification using vibration (including a sound) and a notification using a tactile sensation can be applied as a configuration in which the master 1A or the slave 1B notifies a crew of information. The “notification using vibration” as mentioned herein also includes a bone conduction notification using a device such as an earphone. In addition, a notification using a tactile sensation (a feedback using a tactile sensation) can also be applied as a configuration in which the master 1A or the slave 1B notifies a crew of information.

Hereinafter, the feedback using a tactile sensation will be briefly described. For example, the master 1A or the slave 1B is equipped with a tactile sensation feedback function using haptic technology. The haptic technology is known technology for giving a skin sensation feedback to a crew by generating a stimulus such as a stimulus using movement (vibration) or an electrical stimulus.

Incidentally, a boat race is performed on the water, and thus it is considered that a notification using vibration (particularly, vibration of an object such as a body) or a notification using a tactile sensation is appropriate as a configuration in which a crew is notified of data during a race or practice.

In addition, in a case where a feedback using a tactile sensation is used, it is preferable that a tactile stimulus for hurrying a rowing operation is given to a rower of which the rowing operation is relatively delayed, and a tactile stimulus for slowing down a rowing operation is given to a rower of which the rowing operation is relatively advanced.

In addition, in a case where a notification using a sound (vibration of air) is applied, it is preferable that an alarm sound, a beep sound (buzzer sound), and the like are preferably used. The alarm sound and the beep sound (buzzer sound) may be set to be a characteristic sound (a sound having an unstable pitch, a dissonance, or the like) so that a crew can make a distinction from noise.

In addition, an alarm sound or an announcement sound may be used instead of the beep sound (buzzer sound). A sound such as “advancing” or “delaying” may be used as the announcement sound. In addition, a sound, such as “greatly deviating”, which indicates the degree of a deviation may be used as the announcement sound.

### 2-3. Function of Setting Deviation Allowable Range

In addition, the master 1A of the above-described embodiment transmits delay data with respect to the slave 1B of the rower 2b′ basically at the same frequency as a pitch of rowing and omits transmission in a case where the delay data is zero, but may omit transmission in a case where the delay data is within an allowable range.

For example, the master 1A may perform transmission to the corresponding slave 1B in a case where delay data exceeds the allowable range, and may not perform transmission to the slave 1B in a case where the delay data does not exceed the allowable range. Meanwhile, in this case, the cox 2a may be able to previously set an allowable range with respect to the master 1A.

In addition, the master 1A of the above-described embodiment transmits variation data with respect to the slave 1B of the stroke rower 2b basically at the same frequency as a pitch of rowing, but may omit transmission in a case where the variation data is within an allowable range.

For example, the master 1A may perform transmission to the slave 1B of the stroke rower 2b in a case where the variation data exceeds the allowable range, and may not perform transmission to the slave 1B in a case where the variation data does not exceed the allowable range. Meanwhile, in this case, the cox 2a may previously set an allowable range with respect to the master 1A.

For example, the master 1A may give notice to the cox 2a in a case where the variation data exceeds the allowable range, and may not give notice to the cox 2a in a case where the variation data does not exceed the allowable range. Meanwhile, in this case, the cox 2a may previously set an allowable range with respect to the master 1A.

2-4. Function when Deviation is Zero

Meanwhile, the system of the above-described embodiment may be operated, for example, in any one of the following manners of (1) to (3) in a case where there is no deviation (deviation is zero) or in a case where a deviation is within an allowable range.

(1) The master 1A does not transmit (omits transmission) data (delay data or the like) to the slave 1B in a case where there is no deviation (that is, zero) or in a case where the degree of a deviation has a value equal to or less than a predetermined value. In this case, the slave 1B does not notify a user (rower) of delay data or the like (omits notification).

(2) The master 1A transmits data (delay data or the like) to the slave 1B in a case where there is no deviation (that is, zero) or in a case where the degree of a deviation has a value equal to or less than a predetermined value. On the other hand, even when the slave 1B receives data (delay data or the like), the slave does not give notice to a user (rower) in a case where there is no deviation (that is, zero) or in a case where the degree of a deviation has a value equal to or less than a predetermined value.

(3) The master 1A transmits data (delay data or the like) to the slave 1B even when there is no deviation (that is, zero) or even when the degree of a deviation has a value equal to or less than a predetermined value. On the other hand, when the slave 1B receives data (delay data or the like), the slave notifies a user (rower) that there is no deviation or that the degree of a deviation has a value equal to or less than a predetermined value. That is, the slave 1B notifies the user (rower) of being synchronous, an operation being coincident, or synchronization being satisfactory.

### 2-5. Navigation Function

In the above-described embodiment, delay data and variation data have been described as data to be notified to a crew, but the master 1A and the slave 1B are equipped with various sensors other than an acceleration sensor. Therefore, it is also possible to notify the crew of information other than the delay data and the variation data.

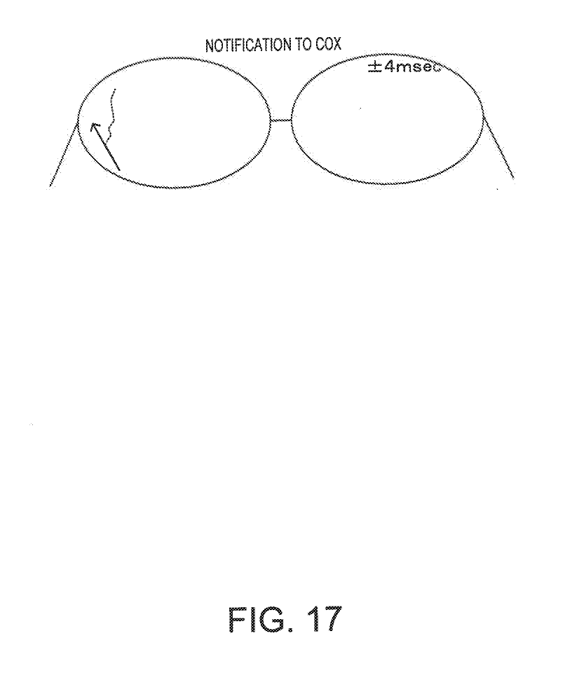

For example, the processing unit 120 of the master 1A may notify the cox 2a of a scheduled route (simple map) between a target point (way point) which is previously registered and a present point, a direction (target direction) toward the target point from the present point, a direction (direction to be corrected) of a difference between the present advance direction and a target direction, and the like, on the basis of positioning data indicated by an output of the GPS sensor 110 mounted to the master 1A. FIG. 17 illustrates an example of information notified to the cox 2a by using an HMD. In FIG. 17, a scheduled route is indicated by a dotted line, and a direction to be corrected (an example of information indicating a deviation of a movement direction from a predetermined direction) is indicated by an arrow. In this manner, it is considered that the display of data regarding the position of a boat increases a possibility that variation data and the like are effectively utilized.

Similarly, the processing unit 120 of the master 1A may give notice to the cox 2a (may perform display using an HMD) by using a configuration in which a scheduled route and an actual course can be distinguished from each other (for example, by using images of different types of polygonal lines).

In addition, the processing unit 120 of the master 1A may detect the posture of the master 1A (that is, the posture of the boat) by using at least a portion of the acceleration sensor 113, the angular velocity sensor 114, the geomagnetic sensor 111, and the GPS sensor 110 which are mounted to the master 1A, and may notify the cox 2a of the detected posture. In addition, the processing unit 120 of the master 1A may notify the cox 2a of changes in the posture of the boat with time as an image such as a graph. By this notification, the cox 2a may timely ascertain whether or not the boat snakes or correctly advances.

Meanwhile, the processing unit 120 of the master 1A may use a sensor mounted to the master 1A, may use a sensor mounted to at least one of the eight slaves 1B, or may use a sensor having the highest reliability among sensors mounted to the master 1A and the eight slaves 1B, in order to detect the position or posture of the boat. The sensor having the highest reliability means, for example, a sensor having the best reception environment of a GPS signal. Information regarding the quality of the reception environment is included in positioning data.

In addition, a portion or all of the above-mentioned navigation functions of the master 1A can also be provided on the slave 1B side.

### 2-6. Performance Notification Function

In addition, the processing unit 120 of the master 1A may sequentially collect pieces of sensing data which are output by the atmospheric pressure sensor 112, the acceleration sensor 113, the angular velocity sensor 114, the pulse sensor 115, and the temperature sensor 116 which are mounted to the slave 1B, and may sequentially notify the cox 2a of pieces of performance information (reference numeral 130b of FIG. 2) of individual rowers which are indicated by the pieces of sensing data (performance notification function). In this case, the cox 2a can ascertain the performance of the individual rowers and the performance of all crews during a race or practice.

In addition, a portion or all of the above-mentioned performance notification functions of the master 1A can also be provided on the slave 1B side. However, in this case, pieces of information notified to the rowers 2b′ by the respective slaves 1B may be limited to only information regarding the rowers 2b′.

### 2-7. With Regard to Modification Example of System Configuration

In the system of the above-described embodiment, each of the slaves 1B detects a rowing operation of each of respective rowers and performs the control of a measurement flag in the entire system by using a timing of the detection, but the master 1A may detect the operation (an arm swing operation, voice output, and the like) of the cox 2a and may perform the control of a measurement flag in the entire system by using a timing of the detection.

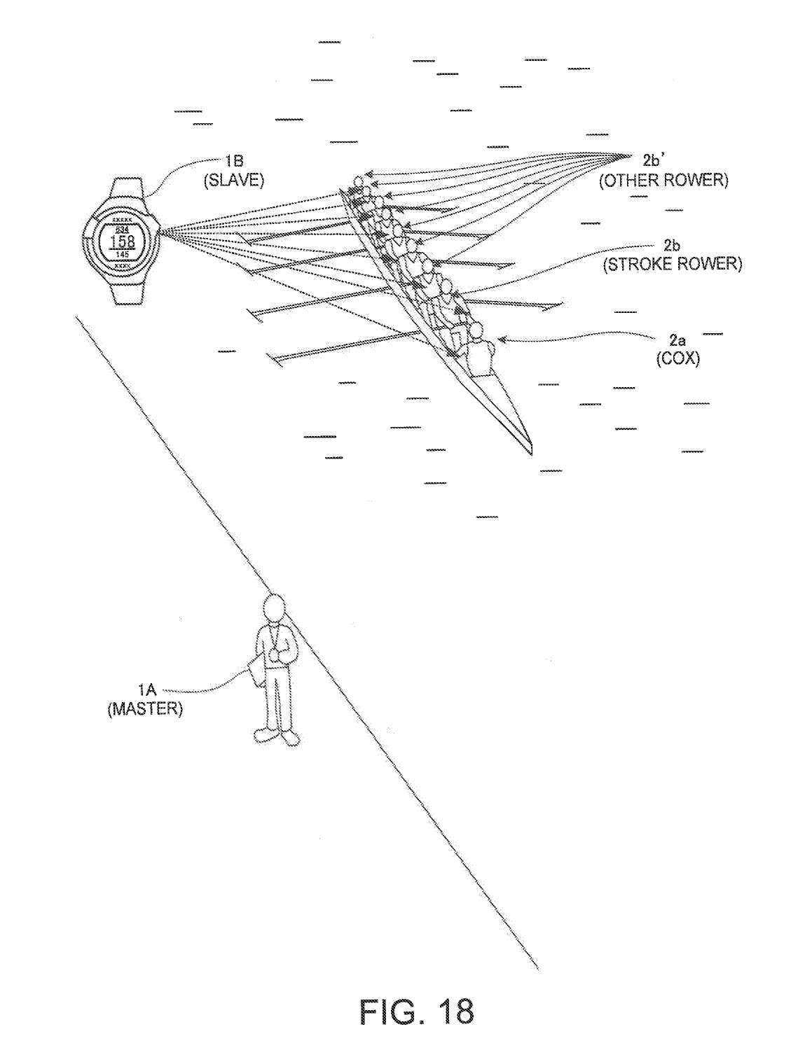

In the above-described embodiment, a description has been given of a case where the cox 2a wears the master 1A and the rowers 2b and 2b′ wear the slave 1B, but all crews may wear the slave 1B and a leader on land or the like may wear the master 1A. Since the leader on land does not exercise, the master 1A may be constituted by, for example, a tablet personal computer (PC), for example, as illustrated in FIG. 18, instead of being constituted by a wearable information terminal. A display unit of the tablet PC is larger in size than that of the wearable information terminal, and thus it is possible to notify a leader or the like of more detailed information. For example, the tablet PC may also simultaneously display pieces of delay data for the respective rowers or may display changes in the pieces of delay data for the respective rowers with time as a graph.

In addition, the master 1A of the above-described embodiment detects a deviation (delay data) in a timing of a rowing operation of each of the other rowers 2b′ based on a timing of a rowing operation of a certain rower (stroke rower 2b), but may detect a deviation (delay data) in a timing of a rowing operation of each of the rowers based on an average timing of the rowing operations of all of the rowers. Alternatively, the master 1A of the above-described embodiment may detect a deviation (delay data) in a timing of a rowing operation of a certain rower on the basis of an average timing of operations of the other rowers.

Particularly, in a case where there are two rowers, the master 1A may transmit delay data based on a rowing operation of a second rower to a slave 1B of a first rower, and may transmit delay data based on a rowing operation of the first rower to a slave 1B of the second rower. In this case, the delay data transmitted to the slave 1B of the first rower and the delay data transmitted to the slave 1B of the second rower have a relationship of equivalent opposite signs.

In addition, a portion or all of the functions of the master 1A of the above-described embodiment maybe provided in at least one slave 1B (an example of a configuration in which one of the second sensor and the first sensor is integrally formed with an operation information providing apparatus). In addition, a portion or all of the functions of the master 1A of the above-described embodiment maybe dispersively provided in two or more slaves 1B.

### 2-8. With Regard to Field

In addition, in the above-described embodiment, a description has been given of an example of a boat race (a so-called eight) of an event in which boat crews are constituted by eight rowers and one cox, but the above-described system can also be applied to a boat race of a different number of persons or another event.

In the above-described embodiment, a boat race has been described, but the invention is effective in analyzing various operations such as group dance, formation march, support, a tug of war, cheerleading, ground practice of synchronized swimming, and group movement in a live hall. Particularly, these fields are suitable for a case where a plurality of persons repeat a predetermined same operation. For example, in ground practice of synchronized swimming, all players are required to perform the same movement, and thus it is possible to expect to raise scores by applying the system of this embodiment.

### 2-9. Others

In the above-described embodiment, a portion or all of the functions of the slave 1B other than a sensor function maybe provided in a portable information terminal (a so-called smart phone or the like) which is carried by a rower serving as a wearing destination of the slave 1B. Similarly, a portion or all of the functions of the master 1A may be provided in a portable information terminal (a smart phone or the like) which is carried by the cox 2a.

In the above-described embodiment, a plurality of types of sensors mounted to the slave 1B have been described, but a portion of the plurality of types of sensors may also be omitted. For example, it is also possible to omit sensors other than an acceleration sensor.

In the above-described embodiment, a plurality of types of sensors mounted to the master 1A have been described, but a portion of the plurality of types of sensors may also be omitted.

In the above-described embodiment, a portion or all of the functions of the master 1A may be provided on sides of a portion or all of the slaves 1B. In addition, a portion or all of the functions of the slave 1B may be provided on the master 1A side.

In the above-described embodiment, one of a plurality of information terminals constituting the system is equipped with a function of a master, and the other information terminals are equipped with a function of a slave. However, all of the information terminals may be equipped with both the functions of the master and the slave. In this case, a user can switch between functions revealed in the information terminals through a menu screen or the like.

In the above-described embodiment, a description has been mainly given of an example in which each of the plurality of information terminals constituting the system is configured as a wrist type, but at least one of the plurality of information terminals can be configured as any of various types such as an earphone type, a ring type, a pendant type, a type used by being mounted to a sports apparatus, a smartphone type, and a built-in HMD. However, it is preferable that an information terminal to be carried by a user who is a target for the detection of movement is configured to be mounted to the user's body or a sports apparatus used by the user.

In the above-described embodiment, a global positioning system (GPS) is used as a global satellite positioning system, but another global navigation satellite system (GNSS) may be used. For example, one or two or more of satellite positioning systems such as a European geostationary-satellite navigation overlay service (EGNOS), a quasi zenith satellite system (QZSS), a global navigation satellite system (GLONASS), a GALILEO, and a beidou navigation satellite system (BeiDou) may be used. In addition, a satellite-based augmentation system (SBAS) such as a wide area augmentation system (WAAS) or a European geostationary-satellite navigation overlay service (EGNOS) may be used for at least one of the satellite positioning systems.

The above-described embodiment and the modification example are merely examples and are not limited thereto. For example, the embodiment and the modification example can also be appropriately combined with each other.

The invention includes substantially the same configurations (for example, configurations having the same functions, methods, and results, or configurations having the same objects and effects) as those described in the embodiment. In addition, the invention includes a configuration in which an inessential portion of the configuration described in the embodiment is changed. In addition, the invention includes a configuration exhibiting the same operational effects as the configuration described in the embodiment, or a configuration capable of achieving the same objects. In addition, the invention includes a configuration in which a known technique is added to the configuration described in the embodiment.

The entire disclosure of Japanese Patent Application No. 2016-030999, filed Feb. 22, 2016 is expressly incorporated by reference herein.

What is claimed is:

1. An operation information providing apparatus providing information regarding a repetitive operation which is synchronously performed by a first user and a second user, the operation information providing apparatus comprising:
a processor that detects a deviation of a timing of an operation of the second user based on a timing of an operation of the first user by using an output of a first sensor detecting the operation of the first user and an output of a second sensor detecting the operation of the second user; and
an output unit that outputs information indicating a state of the deviation of a case where the deviation is detected.

2. The operation information providing apparatus according to claim 1,
wherein the output unit outputs information indicating a degree of the deviation.

3. The operation information providing apparatus according to claim 1,
wherein the output unit starts outputting the information in a case where it is detected that the first user and the second user perform a predetermined operation, by using the outputs of the first sensor and the second sensor.

4. The operation information providing apparatus according to claim 1,
wherein the processor detects the deviation on the basis of a phase difference between a signal indicating changes in the output of the first sensor with time and a signal indicating changes in the output of the second sensor with time.

5. The operation information providing apparatus according to claim 4,
wherein the processor uses a cycle of the repetitive operation for detection of the phase difference.

6. The operation information providing apparatus according to claim 5,
wherein the processor performs correlation computational calculation on the signal indicating changes in the output of the first sensor with time and the signal indicating changes in the output of the second sensor with time to thereby detect the phase difference.

7. The operation information providing apparatus according to claim 1,
wherein the operation of the first user and the operation of the second user are operations accompanied by movements of the first user and the second user, and
wherein the output unit outputs information indicating a deviation of a movement direction of the first user or the second user from a predetermined direction.

8. The operation information providing apparatus according to claim 1,
wherein the operation of the first user and the operation of the second user are rowing operations in a boat race.

9. The operation information providing apparatus according to claim 1,
wherein the first sensor and the second sensor are inertia sensors.

10. An operation information providing system providing information regarding a repetitive operation which is synchronously performed by a first user and a second user, the operation information providing system comprising:
a first sensor;
a second sensor; and
an operation information providing apparatus including a processor that detects a deviation of a timing of an operation of the second user based on a timing of an operation of the first user by using an output of the first sensor detecting the operation of the first user and an output of the second sensor detecting the operation of the second user, and an output unit that outputs information indicating a state of the deviation of a case where the deviation is detected.

11. The operation information providing system according to claim 10, further comprising:
a notification device that notifies the second user of the information indicating positive and negative.

12. The operation information providing system according to claim 11,
wherein the notification device notifies the second user of the information indicating the state in accordance with at least one of a color, a sound, a vibration, an image, a color change pattern, a sound change pattern, a vibration change pattern, and an image change pattern.

13. The operation information providing system according to claim 12,
wherein there is a difference in at least one of a color, a sound, a vibration, an image, a color change pattern, a sound change pattern, a vibration change pattern, and an image change pattern, which are used for the notification, between a case where the deviation is positive and a case where the deviation is negative.

14. The operation information providing system according to claim 10,
wherein the second sensor is integrally formed with the notification device.

15. The operation information providing system according to claim 10,
wherein one of the second sensor and the first sensor is integrally formed with the operation information providing apparatus.

16. An operation information providing method of providing information regarding a repetitive operation which is synchronously performed by a first user and a second user, the operation information providing method comprising:
detecting a deviation of a timing of an operation of the second user based on a timing of an operation of the first user by using an output of a first sensor detecting the operation of the first user and an output of a second sensor detecting the operation of the second user; and
outputting information indicating a state of the deviation of a case where the deviation is detected.

17. The operation information providing method according to claim 16,
wherein the outputting of the information includes outputting information indicating degree of the deviation.

18. The operation information providing method according to claim 16,
wherein the outputting of the information includes starting outputting the information in a case where it is detected that the first user and the second user perform a predetermined operation, by using the outputs of the first sensor and the second sensor.

19. The operation information providing method according to claim 16,
wherein the detecting of the deviation includes detecting the deviation on the basis of a phase difference between a signal indicating changes in the output of the first sensor with time and a signal indicating changes in the output of the second sensor with time.

20. The operation information providing method according to claim 19,
wherein the detecting of the deviation includes using a cycle of the repetitive operation for detection of the phase difference.

21. The operation information providing method according to claim 20,
wherein the detecting of the deviation includes performing correlation computational calculation on the signal indicating changes in the output of the first sensor with time and the signal indicating changes in the output of the second sensor with time to thereby detect the phase difference.

22. The operation information providing method according to claim 16,
wherein the operation of the first user and the operation of the second user are operations accompanied by movements of the first user and the second user, and
wherein the outputting of the information includes outputting information indicating a deviation of a movement direction of the first user or the second user from a predetermined direction.

23. The operation information providing method according to claim 16,
wherein the operation of the first user and the operation of the second user are rowing operations in a boat race.

24. The operation information providing method according to claim 16,
wherein the first sensor and the second sensor are inertia sensors.

25. A recording medium having an operation information providing program, providing information regarding a repetitive operation which is synchronously performed by a first user and a second user, recorded thereon, the operation information providing program causing a computer to execute steps of:
detecting a deviation of a timing of an operation of the second user based on a timing of an operation of the first user by using an output of a first sensor detecting the operation of the first user and an output of a second sensor detecting the operation of the second user; and
outputting information indicating a state of the deviation of a case where the deviation is detected.
